(19) United States
(12) Patent Application Publication
(10) Pub. No.: US 2022/0035840 A1
(43) Pub. Date: Feb. 3, 2022

(54) DATA MANAGEMENT DEVICE, DATA MANAGEMENT METHOD, AND PROGRAM

(71) Applicant: HONDA MOTOR CO., LTD., Minato-ku, Tokyo (JP)

(72) Inventor: Ryo Nakayama, Wako-shi (JP)

(21) Appl. No.: 17/298,967

(22) PCT Filed: Dec. 6, 2018
(86) PCT No.: PCT/JP2018/044913

§ 371 Date: Jun. 2, 2021

(51) Int. Cl. G06F 16/28; G06Q 30/02; G06Q 20/14

(52) U.S. Cl. CPC G06F 16/285; G06Q 20/145; G06Q 30/0283

(57) ABSTRACT

A data management device includes a collection part configured to collect data of a user from a terminal device of the user or a device of a service provider that provides information to the user, a classification part configured to classify the data of the user that is a target to be collected by the collection part into groups on the basis of a predetermined regulation, a usage condition setting part configured to set one or more usage conditions of the data classified into the groups by the data classification part for each of the groups, and a providing part configured to provide the data to an outside on the basis of the usage condition of each of the groups set by the usage condition setting part.

### TECHNICAL FIELD

The present invention relates to a data management device, a data management method, and a program.

### BACKGROUND ART

In recent years, technologies of using data collected from service users for various purposes such as research and development or improvement in service quality have been known (for example, see Patent Literature 1).

### CITATION LIST

### Patent Literature

### [Patent Literature 1]

Japanese Unexamined Patent Application, First Publication No. 2018-037002

### SUMMARY OF INVENTION

### Technical Problem

Incidentally, according to the General Data Protection Regulation (GDPR), it may not be preferable to use data collected from non-service users without permission of the users. In the related art, it is difficult to inquire of users whether the data collected from the users may be used for various purposes. In addition, in some cases, it is troublesome for the users to answer whether the collected data may be used for various purposes one by one.

In consideration of the above-mentioned circumstances, an aspect of the present invention is directed to providing a data management device, a data management method, and a program that are capable of acquiring permission to use data collected from users from the users while reducing effort of the users.

### Solution to Problem

A data management device, a data management method, and a program according to the present invention employ the following configurations.

(1) A data management device according to an aspect of the present invention is a data management device including a collection part configured to collect data of a user from a terminal device of the user or a device of a service provider that provides information to the user; a classification part configured to classify the data of the user that is a target to be collected by the collection part into groups on the basis of a predetermined regulation; a usage condition setting part configured to set one or more usage conditions of the data classified into the groups by the data classification part for each of the groups; and a providing part configured to provide the data to an outside on the basis of the usage condition of each of the groups set by the usage condition setting part.

(2) In the data management device according to the above-mentioned (1), the predetermined regulation is a regulation that classifies the data into groups on the basis of a degree of privacy applied to the data in advance, and the usage condition setting part makes the usage condition of data of a first group stricter than the usage condition of data of a second group to which data having a lower degree of privacy than the data of the first group belongs.

(3) In the data management device according to the above-mentioned (1) and (2), the predetermined regulation is a regulation that classifies data having same category or attribute into a same group.

(4) The data management device according to the above-mentioned (1) to (3) further includes a notification part configured to notify the user of the terminal device about a candidate for the usage condition of the data for each of the groups; and a usage condition acquisition part configured to acquire the usage condition of the data with respect to the candidate for the usage condition of the data for each of the groups notified of by the notification part, and the usage condition setting part sets the usage condition for each of the groups on the basis of the usage condition acquired by the usage condition acquisition part.

(5) In the data management device according to the above-mentioned (1) to (4), the usage condition includes at least one of whether collection of the data is allowed, a range of a disclosure recipient of the data, a disclosure range of the data to the disclosure recipient, and a disclosure time or period of the data to the disclosure recipient.

(6) The data management device according to the above-mentioned (1) to (5) further includes a price calculation part configured to calculate a price paid to the user by the service provider with respect to the disclosed data on the basis of the usage condition set by the usage condition setting part; and a payment processing part configured to perform processing of causing the service provider to pay the price calculated by the price calculation part to the user.

(7) In the data management device according to the above-mentioned (6), the price calculation part calculates the price on the basis of a range of the disclosure recipient of the data or a disclosure range of the data.

(8) In the data management device according to the above-mentioned (6) and (7), the price calculation part calculates the price on the basis of a degree of rarity applied to the data in advance or a degree of demand applied to the data in advance.

(9) The data management device according to the above-mentioned (1) to (8) further includes a management cost calculation part configured to calculate management cost of the data paid to the service provider by the user with respect to the data that is not disclosed on the basis of the usage condition set by the usage condition setting part; and a payment processing part configured to perform processing of causing the user to pay the management cost calculated by the management cost calculation part to the service provider.

(10) The data management device according to the above-mentioned (1) to (9) further includes an extraction part configured to extract the data or some of the data on the basis of the usage condition set by the usage condition setting part from one or more pieces of data classified into the groups by the data classification part, and the providing part provides the data or some of the data extracted by the extraction part to the outside.

(11) The data management device according to the above-mentioned (1) to (10) is provided on the moving body and further includes a detector configured to detect that the user has boarded the moving body; a notification part configured to notify the user of the terminal device about the candidate for the usage condition of the data for each of the groups when the detector detects that the user has boarded the moving body; and a usage condition acquisition part configured to acquire the usage condition of the data with respect to the candidate for the usage condition of the data for each of the groups notified of by the notification part, and the usage condition setting part sets the usage condition for each of the groups on the basis of the usage condition acquired by the usage condition acquisition part.

(12) The data management device according to the above-mentioned (1) to (10) further includes a detector configured to detect that the user has boarded the moving body; a notification part configured to notify the user of the terminal device about the candidate for the usage condition of the data for each of the groups when the detector detects that the user has boarded the moving body; and a usage condition acquisition part configured to acquire the usage condition of the data with respect to the candidate for the usage condition of the data for each of the groups notified of by the notification part, and the usage condition setting part sets the usage condition for each of the groups on the basis of the usage condition acquired by the usage condition acquisition part.

(13) In the data management device according to the above-mentioned (1) to (12), the data of the user includes moving body information related to an inside and the outside of the moving body, and the collection part collects the moving body information even when the user is not boarding the moving body.

(14) In the data management device according to the above-mentioned (1) to (13), the collection part discards the data of the group in which the usage condition was not set without collecting it.

(15) In the data management device according to the above-mentioned (4), (11) or (12), the notification part notifies the user that the data is provided to the service provider when the usage condition is not set for the data.

(16) The data management device according to the above-mentioned (1) to (15) further includes an interpretation part configured to acquire a sound of the user and interpret content of speech of the user contained in the acquired sound; and an agent controller configured to generate a sound that speaks to the user on the basis of the content of the speech interpreted by the interpretation part, and the collection part collects the data of the user on the basis of the content of the speech of the user interpreted by the interpretation part.

(17) In the data management device according to the above-mentioned (16), the agent controller generates a sound that provides a candidate for the usage condition which is set for each of the groups or each piece of the data, the interpretation part interprets content of the user's speech that selects the usage condition on the basis of the candidate for the usage condition provided by the agent controller, and the usage condition setting part sets the usage condition selected by the user for each of the groups or for each piece of the data on the basis of the content of the user's speech interpreted by the interpretation part.

(18) A data management method of causing a computer to: collect data of a user from a terminal device of the user or a device of a service provider that provides information to the user, classify the data of the user that is a target to be collected into groups on the basis of a predetermined regulation, set one or more usage conditions of data classified into the groups for each of the groups, and provide the data to an outside on the basis of the set usage condition of each of the groups.

(19) A program configured to cause a computer to: collect data of a user from a terminal device of the user or a device of a service provider that provides information to the user, classify the data of the user that is a target to be collected into groups on the basis of a predetermined regulation, set one or more usage conditions of data classified into the groups for each of the groups, and provide the data to an outside on the basis of the set usage condition of each of the groups.

### Advantageous Effects of Invention

According to the above-mentioned (1) to (19), it is possible to obtain from the user usage allowance of the data collected from the user while reducing time and effort of the user.

According to the above-mentioned (2), it is possible to obtain enhanced use of the data from the user in view of the privacy of the data collected from the user.

According to the above-mentioned (4), it is possible to conveniently obtain from the user the usage condition of the data collected from the user.

According to the above-mentioned (6), it is possible to apply a price to the user by disclosing the data collected from the user.

According to the above-mentioned (7), it is possible to apply a larger number of prices to the user as rarer data or data with a higher demand is disclosed.

According to the above-mentioned (9), it is possible to easily collect the data management cost from the user as the data collected from the user is not disclosed.

According to the above-mentioned (11) and (12), it is possible to obtain from the user usage allowance of the data collected from the user in the moving body while reducing time and effort of the user.

According to the above-mentioned (16) and (17), it is possible to obtain from the user usage allowance of the data collected from the user without depending on an operation of the user.

### BRIEF DESCRIPTION OF DRAWINGS

FIG. 1 is a figure showing an outline of a data reception system 1 of an embodiment.

FIG. 2 is a figure showing an example of a configuration of a data management device 10 according to the embodiment.

FIG. 3 is a figure showing an example of content of data DT collected by a collection part 101.

FIG. 4 is a figure showing an example of content of predetermined regulation information 121.

FIG. 5 is a figure showing an example of content of the data DT for every data group G1 stored in a server device SV.

FIG. 6 is a figure showing an example of the inside of a vehicle V.

FIG. 7 is a figure showing an example of a conversation between an agent and a user.

FIG. 8 is a figure showing another example of a conversation between an agent and a user.

FIG. 9 is a figure showing an example of content of the data DT collected by the collection part 101 on the basis of a conversation between an agent and a user.

FIG. 10 is a figure showing an example of content of predetermined regulation information 121a which is set so as to classify data DT, in which a category is “meal information”, as one data group G1.

FIG. 11 is a figure showing an example of content of the data DT in which a privacy level is included as an element.

FIG. 12 is a figure showing an example of content of predetermined regulation information 121b which is set so as to classify the data DT including the privacy level as the data group G1.

FIG. 13 is a figure showing an example of content of the data DT in which an attribute of a user is included as an element.

FIG. 14 is a figure showing an example of content of predetermined regulation information 121c which is set so as to classify the data DT including the attribute as the data group G1.

FIG. 15 is a figure showing an example of a seating sensor C included in the vehicle V.

FIG. 16 is a figure showing an example of an image IM1 displayed on a terminal device TM1.

FIG. 17 is a figure showing an example of an image IM2 displayed on the terminal device TM1.

FIG. 18 is a figure showing an example of an image IM3 displayed on the terminal device TM1.

FIG. 19 is a figure showing an example of an image IM4 displayed on the terminal device TM1.

FIG. 20 is a figure showing an example of an image IM5 displayed on the terminal device TM1.

FIG. 21 is a figure showing an example of content of usage condition information 122.

FIG. 22 is a figure showing an example of content of price information 123.

FIG. 23 is a figure showing an example of content of rare data information 124.

FIG. 24 is a figure showing an example of content of management cost information 125.

FIG. 25 is a flowchart showing an example of a flow of a series of operations in which the data DT is collected.

FIG. 26 is a flowchart showing an example of a flow of a series of operations in which the usage condition information 122 is generated.

FIG. 27 is a flowchart showing an example of a flow of a series of operations in which the data DT is provided to a disclosure recipient.

FIG. 28 is a flowchart showing an example of a flow of a series of operations of payment processing related to the data DT.

FIG. 29 is a figure showing an example of a configuration of a data disclosure device 20 according to the embodiment.

FIG. 30 is a figure showing an example of content of request information RV.

FIG. 31 is a figure showing an example of content of selecting condition information 221.

FIG. 32 is a figure showing an example of content of attribute information 222.

FIG. 33 is a figure showing an example of content of disclosure recipient candidate information 223.

FIG. 34 is a figure showing an example of content of pattern information 224.

FIG. 35 is a figure showing an example of content of disclosure recipient candidate group information 225.

FIG. 36 is a figure showing an example of an image IM3a displayed on a terminal device TM.

FIG. 37 is a flowchart showing an example of a flow of a series of operations of generation processing of the disclosure recipient candidate information 223.

FIG. 38 is a flowchart showing an example of a flow of an operation of an example of processing which adds a disclosure recipient to the disclosure recipient candidate information 223.

### DESCRIPTION OF EMBODIMENTS

Hereinafter, an embodiment of a data management device, a data management method, and a program of the present invention will be described with reference to the accompanying drawings.

### Embodiment

### [Entire Configuration]

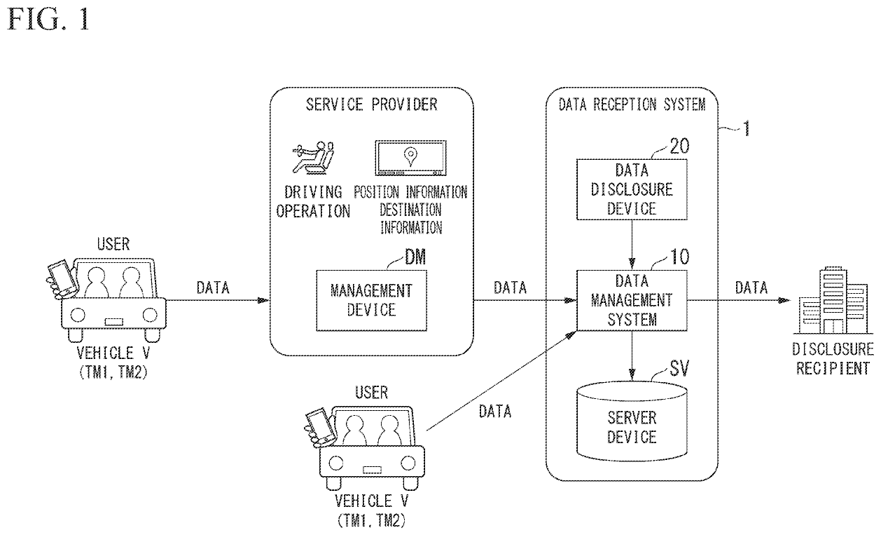

FIG. 1 is a figure showing an outline of a data reception system 1 of an embodiment. The data reception system 1 includes a data management device 10 and a data disclosure device 20. The data management device 10 and the data disclosure device 20 can transmit and receive information to and from each other. The data reception system 1 is a device configured to collect data related to users from a terminal device (hereinafter, a terminal device TM) used by a user who uses a service or from a management device of a service provider (hereinafter, a management device DM) configured to provide the service, and to provide (disclose) the collected data to a disclosure recipient who receives the data (to whom the data is disclosed). For example, the disclosure recipient uses the disclosed data for research and development, or uses the disclosed data to improve the service they provide.

Hereinafter, a case in which a terminal device TM1 is a navigation device provided in a vehicle V that is an example of a moving body, a user is a driver in the vehicle V, and a service used by the user is a route guiding service will be exemplarily described. In addition, the user has the terminal device TM2, and the terminal device TM2 is a portable communication terminal device such as a smartphone or the like, or a portable personal computer such as a tablet computer (tablet PC) or the like. The data collected by the data reception system 1 is, for example, data related to the vehicle (for example, data indicating content of driving operations, data indicating a current position of the vehicle, data indicating a destination, and the like). In addition, the data collected by the data reception system 1 is, for example, data related to an application executed in the terminal device TM2. In the following description, when the terminal device TM1 and the terminal device TM2 are not discriminated from each other, they are generally referred to as the terminal device TM.

### [With Respect to Data Management Device 10]

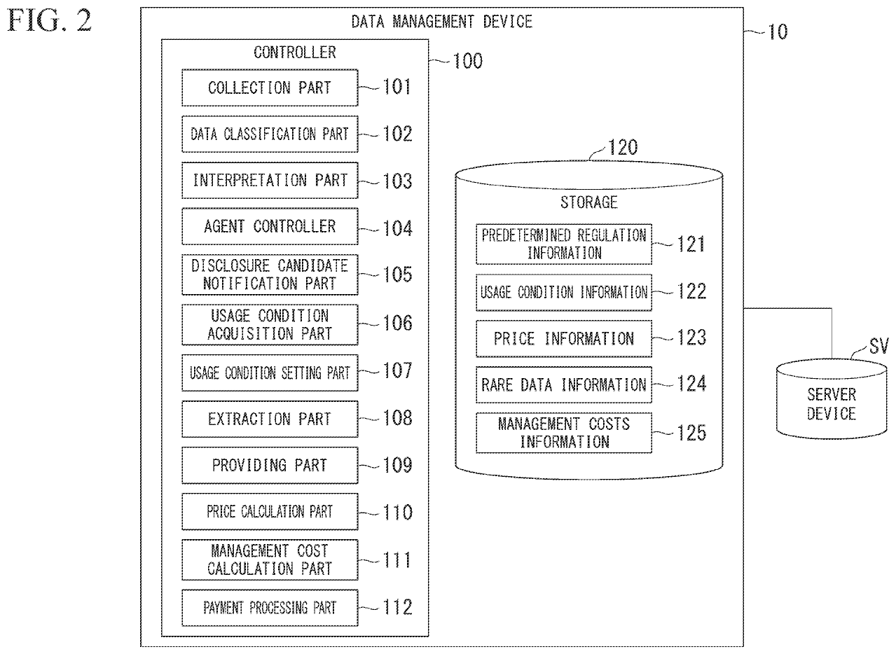

FIG. 2 is a figure showing an example of a configuration of the data management device 10 according to the embodiment. As shown in FIG. 2, the data management device 10 is connected to a server device SV, and stores the collected data in the server device SV. The server device SV includes a storage device such as a hard disk drive (HDD), a flash memory, or the like. In addition, a part or the entirety of the server device SV may be an accessible external device of the data management device 10, for example, a network attached storage (NAS), an external storage server, or the like.

The data management device 10 includes a controller 100 and a storage 120. The controller 100 realizes function units of a collection part 101, a data classification part 102, an interpretation part 103, an agent controller 104, a disclosure candidate notification part 105, a usage condition acquisition part 106, a usage condition setting part 107, an extraction part 108, a providing part 109, a price calculation part 110, a management cost calculation part 111 and a payment processing part 112 by executing a program (software) stored in the storage 120 using a hardware processor such as a central processing unit (CPU) or the like. In addition, some or all of these components may be realized by hardware (a circuit part; including circuitry) such as large scale integration (LSI), an application specific integrated circuit (ASIC), a field-programmable gate array (FPGA), a graphics processing unit (GPU), or the like, or may be realized by software and hardware in cooperation.

The storage 120 may be realized by, for example, a storage device (a storage device including a non-transient storage medium) such as an HDD, a flash memory, or the like, may be realized by a detachable storage medium (a non-transient storage medium) such as a DVD, a CD-ROM, or the like, or may be a storage medium mounted on a drive device. In addition, a part or the entirety of the storage 120 may be an accessible external device of the data management device 10 such as an NAS, an external storage server, or the like. The storage 120 stores, for example, predetermined regulation information 121, usage condition information 122, price information 123, rare data information 124 and management cost information 125. Details of various pieces of information will be described below.

The collection part 101 communicates with the terminal device TM or the management device DM using a network such as a cellular network, a Wi-Fi network, Bluetooth (registered trademark), dedicated short range communication (DSRC), a wide area network (WAN), a local area network (LAN), or the like, and collects various pieces of data. As described above, the terminal device TM1 is, for example, a navigation device, and an operation of setting a destination, an operation of retrieving a route, an operation of an audio device integrated with the terminal device TM1, and the like are performed in the terminal device TM1 by the user. The management device DM acquires data indicating content of various types of operations (for example, a driving operation) performed in the vehicle V by the user. When collection of data indicating content of an operation performed on the terminal device TM1 or content of an operation performed in the vehicle acquired by the management device DM is allowed by the usage condition information 122, the collection part 101 collects the data from the terminal device TM1.

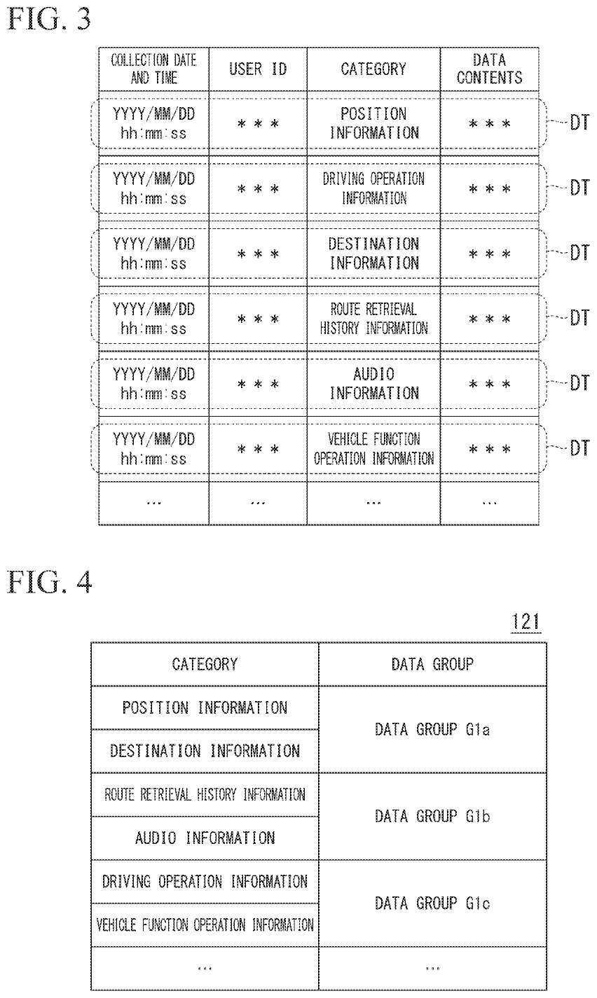

FIG. 3 is a figure showing an example of content of data DT collected by the collection part 101. The collection part 101 collects, for example, a record including a collection date and time, identification information that enables identification of a user (hereinafter, a user ID), a category of collected data, and content of data as a piece of data DT. “Category” in the data DT is classified as information that roughly indicates data content, for example, “position information,” “driving operation information,” “destination information,” “route retrieval history information,” “audio information,” “vehicle function operation information,” and the like. “Position information” is information indicating, for example, a current position of the vehicle V. “Destination information” is information indicating, for example, a destination of the vehicle V. “Driving operation information” is information indicating, for example, a driving operation performed by an occupant in the vehicle V (for example, a rotation angle of a handle, brake pedal depression, accelerator pedal depression, or the like). “Route retrieval history information” is information indicating, for example, a retrieval history of routes to the destination retrieved by an occupant (for example, a user) in the vehicle V. “Audio information” is information related to, for example, a sound output from an audio device included in the vehicle V (for example, information indicating a title, a radio station, a television channel, and the like). “Vehicle function operation information” is information indicating, for example, an operation history of a driving assistance system included in the vehicle V.

Further, these categories are exemplary and not limited thereto, and information different from these (for example, “fuel consumption information,” “traveling kilometers information,” “car inspection period information,” and the like) may be included as long as it is information related to the vehicle V. In addition, the data DT acquired in the vehicle may include a talk in the vehicle, communication with an agent of the vehicle which will be described below (a talk, a gesture, or the like), an image photographed by the in-vehicle camera, an analysis result of the image (a facial expression, a line of sight, a posture, emotion, or the like, of the user), bio information, a room temperature, a terminal such as a smartphone or the like connected to the vehicle, application information, communication by telephones, a time while the user is on the vehicle, the number of persons on the vehicle, attribute information (described below) of a user, peripheral information of the vehicle (an image captured by a vehicle-outside camera, sound outside the vehicle, or the like), and the like.

In addition, the collection part 101 may collect the data DT acquired in timing when the user is not in the vehicle V, in addition to the operation performed by the user. The data DT acquired in the timing when the user is not in the vehicle V is, for example, a vehicle-outside image showing a circumstance around the vehicle V captured by the camera included in the vehicle V or a vehicle-inside image showing a circumstance in the vehicle V captured by the in-cabin camera included in the vehicle V. The vehicle-outside image or the vehicle-inside image may be acquired with intention of crime prevention, for example, even in timing when the user is not in the vehicle V. The collection part 101 collects the vehicle-outside image or the vehicle-inside image acquired in such timing. The vehicle-outside image and the vehicle-inside image are examples of “moving body information.”

Further, the timing when the user is not in the vehicle V also includes timing when the vehicle V is driven by autonomous driving. In this case, the data DT acquired at a timing when the user is not in the vehicle V includes “position information,” “driving operation information,” “destination information,” “route retrieval history information,” “vehicle function operation information,” and the like, in addition to the vehicle-outside image or the vehicle-inside image.

The data classification part 102 classifies the data DT collected by the collection part 101 into one of data groups G1a, G1b, G1c, . . . on the basis of the predetermined regulation information 121 indicating the predetermined regulation. Hereinafter, when the data groups are not distinguished from each other, it is simply written as a data group G1. FIG. 4 is a figure showing an example of content of the predetermined regulation information 121. The predetermined regulation information 121 is information in which one or more elements (in this example, a category) included in the data DT and the data group G1 are associated with each other. Accordingly, the predetermined regulation indicated by the predetermined regulation information 121 is that “the data DT of the same category is classified into the same data group G1”. In addition, the predetermined regulation indicated by the predetermined regulation information 121 may be “the data DT of categories similar to each other or categories with substantially the same importance (for users, service providers, or disclosure recipients) are classified in the same data group G1.” In the predetermined regulation information 121 of FIG. 4, categories “position information” and “destination information” are associated with each other in the data group G1a, categories “route retrieval history information” and “audio information” are associated with each other in the data group G1b, and categories “driving operation information” and “vehicle function operation information” are associated with each other in the data group G1c. For this reason, the data classification part 102 classifies the data DT having categories “position information” and “destination information” into the data group G1a, classifies the data DT having categories “route retrieval history information” and “audio information” into the data group G1b, and classifies the data DT having categories “driving operation information” and “vehicle function operation information” into the data group G1c. The predetermined regulation is predetermined by, for example, a manager, a user, or a disclosure recipient who manages the data reception system 1.

Further, the predetermined regulation information 121 in FIG. 4 is an example and not limited thereto. Correspondence between the category in the predetermined regulation information 121 and the data group G1 may be appropriately changed or added by, for example, the user, the service provider or the disclosure recipient. In this case, the user, the service provider or the disclosure recipient starts a user agent (UA) such as a browser, an application program, or the like, in his/her own terminal device. The terminal device displays a content screen related to the change of the correspondence between the category and the data group G1 in the UA, and supplies a request that instructs addition, deletion, division, integration, reclassification, and the like, of the data group G1, which is a request according to an input operation performed on the terminal device by the user, to the data reception system 1. The data reception system 1 appropriately changes correspondence between the category and the data group G1 on the basis of the request acquired from the terminal device. In addition, in FIG. 4, while two categories are associated with the data group G1, one or more categories may be associated with the data group G1.

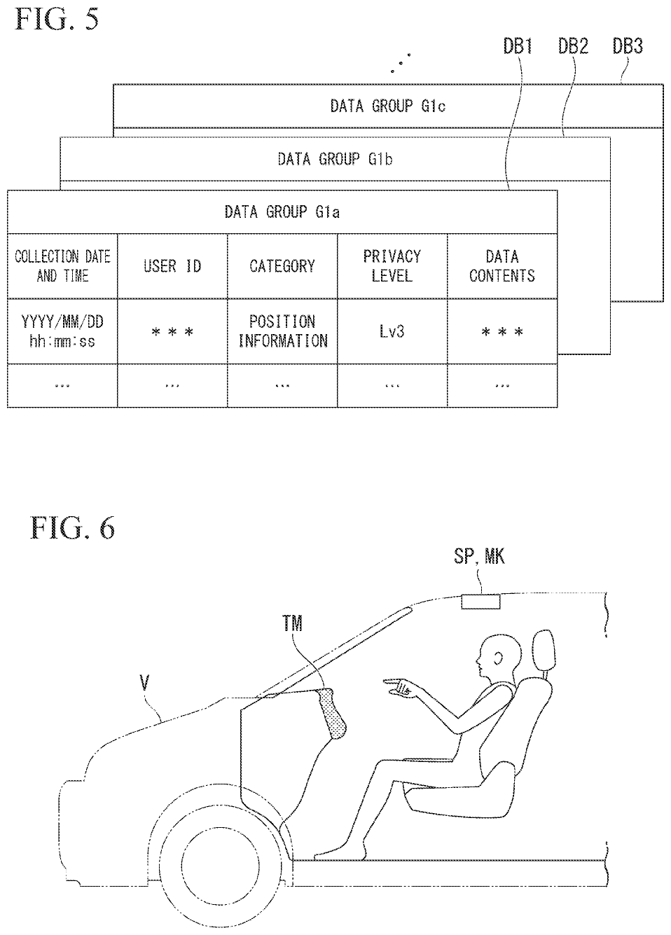

The data classification part 102 classifies the categories included in the data DT into the data group G1 corresponding to the information indicating the categories, and stores the data DT belonging to the classified data group G1 in a database DB corresponding thereto. FIG. 5 is a figure showing an example of content of the data DT of each data group G1 stored in the server device SV. The server device SV stores the database DB (databases DB1 to DB3 shown in the drawing) corresponding to the number of the data groups G1, which is the database DB that stores the data DT classified by the data classification part 102. The data classification part 102 stores the data DT classified into the data group G1a in the database DB1, stores the data DT classified into the data group G1b in the database DB2, and stores the data DT classified into the data group G1c in the database DB3. Accordingly, the data classification part 102 can collectively store the data DT having the same category or the data DT having similar categories in the same database DB.

Further, as described above, while the case in which the collection part 101 collects the data DT indicating content of operations input into the terminal device TM or the management device DM by a user has been described, there is no limitation thereto.

Hereinafter, a case in which the collection part 101 collects the data DT from the conversation with the user will be described.

The interpretation part 103 acquires a user's sound, and interprets content of a user's speech included in the acquired sound. The agent controller 104 generates a sound that speaks to the user on the basis of the content of the speech interpreted by the interpretation part 103. FIG. 6 is a figure showing an example of the inside of the vehicle V. In the vehicle V, for example, a microphone MK is installed at a position where the user's sound can be acquired, and a speaker SP is installed at a position where the user can hear. In FIG. 6, the microphone MK and the speaker SP are installed on a ceiling in the vehicle V. The terminal device TM1 supplies a user's sound acquired by the microphone MK to the data management device 10 (the interpretation part 103). In addition, the terminal device TM1 outputs the sound generated by the agent controller 104 to the speaker SP.

The interpretation part 103 detects a sound segment from a user's sound (sound stream) acquired by the microphone MK. The interpretation part 103 detects, for example, a sound segment on the basis of amplitude and zero crossing of a sound waveform in the sound stream. In addition, the interpretation part 103 may perform segment detection based on sound/non-sound identification of a frame unit based on a Gaussian mixture model (GMM), or may perform segment detection through matching processing with the database to detect the previously stored sound segment. The interpretation part 103 recognizes the sound in the sound segment and converts the sound into text as character information. The interpretation part 103 performs natural language processing on the character information in the text, and interprets meaning of the character information. The natural language processing includes morphological analysis, syntactic analysis, semantic analysis, context analysis, and the like. For example, in the morphological analysis, character information is divided into units of minimum meaningful expression elements, and parts of speech and the like for each divided unit (morpheme) are analyzed. For example, the syntactic analysis analyzes a structure of a sentence based on the morpheme obtained by the morphological analysis. For example, the semantic analysis discriminates meaningful groups based on a syntax obtained by the syntactic analysis. For example, the context analysis interprets the meaning with the sentence unit or the context unit.

For example, when the meaning of the sound interpreted by the interpretation part 103 is a command that instructs the operation of the function provided by the vehicle V, the terminal device TM1 executes a function instructed on the basis of the command. The agent controller 104 generates speech content for conversation with the user on the basis of the character information indicating the content of the speech interpreted by the interpretation part 103. The terminal device TM1 converts the speech content generated by the agent controller 104 into sound, and outputs the converted sound to the speaker SP.

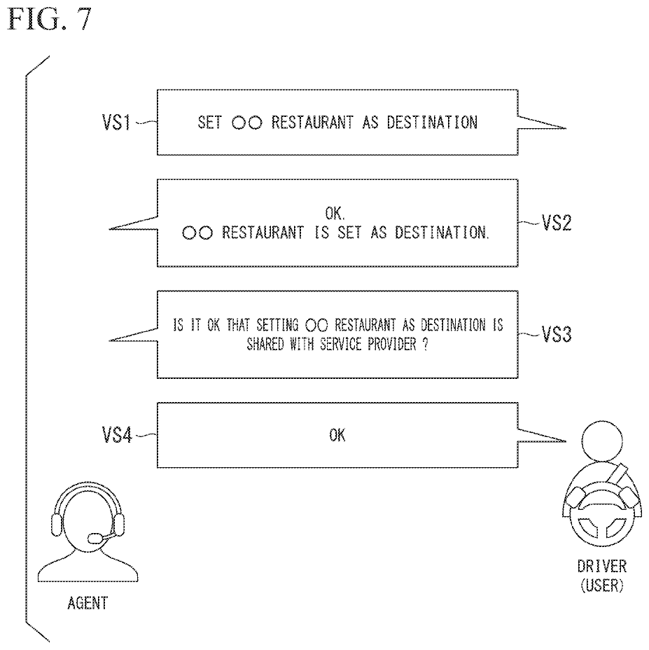

FIG. 7 is a figure showing an example of conversation between an agent and a user. In FIG. 7, the user speaks to the agent the sound “set a destination to ∘∘ restaurant” (a sound VS1 shown in the drawing). On the other hand, the interpretation part 103 interprets the meaning of the sound, and the agent controller 104 generates a sound “OK, ∘∘ restaurant is set as a destination” (a sound VS2 shown in the drawing) in response to the sound interpreted by the interpretation part 103. The terminal device TM1 outputs the sound VS2 generated by the agent controller 104 using the speaker SP. In addition, the terminal device TM1 executes destination setting processing instructed by the sound VS1. By such a talk, the data management device 10 can collect “destination information” as the data DT on the basis of the speech content of the user.

Next, the agent controller 104 generates a sound “is it OK that setting ∘∘ restaurant as a destination is shared with a service provider?” as a sound for inquiring the user again whether collection of the data DT that can be collected is allowed (a sound VS3 shown in the drawing). The terminal device TM1 outputs the sound VS3 generated by the agent controller 104 using the speaker SP. The user speaks a sound that affirms or denies sharing with the provider in response to the agent's question. In FIG. 7, the user speaks a sound “OK” that is intended to be affirmed (a sound VS4 shown in the drawing). The collection part 101 collects the data DT in which the category is “destination information” and data content is “∘∘ restaurant” when the speech content of the user interpreted by the interpretation part 103 is content that affirms to collect the data DT.

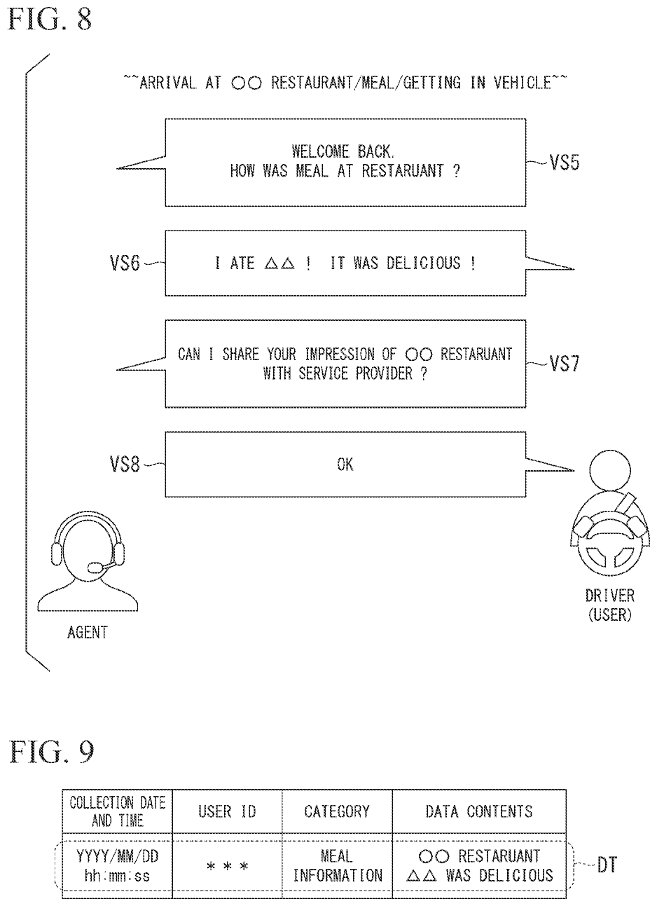

Further, the collection part 101 may collect the data DT other than the data DT related to driving of the vehicle V from the conversation between the agent and the user. FIG. 8 is a figure showing another example of the conversation between the agent and the user. For example, FIG. 8 shows an example of a conversation in timing when the vehicle V was started again after arrival at “∘∘ restaurant” set in FIG. 7 and stopping of the vehicle V. The agent controller 104 generates a sound “Welcome back. How was the meal at the restaurant?” (a sound VS5 shown in the drawing) as a sound for inquiring the user about the impression of the destination (∘∘ restaurant in this example). The terminal device TM1 outputs the sound VS5 generated by the agent controller 104 using the speaker SP. The user speaks to the agent the sound “I ate ΔΔ! It was delicious!” (a sound VS6 shown in the drawing) as an impression at the restaurant. Next, the interpretation part 103 interprets the meaning of the sound, and the agent controller 104 generates a sound “Can I share your impression of ∘∘ restaurant with the service provider?” (a sound VS7 shown in the drawing) as a sound to inquire the user whether collection of the acquired data DT by the data management device 10 is allowed in response to the meaning of the sound interpreted by the interpretation part 103. The terminal device TM1 outputs the sound VS7 generated by the agent controller 104 using the speaker SP. The user speaks a sound that affirms or denies sharing with the provider in response to the agent's question. In FIG. 8, the user speaks a sound “OK” (the sound VS7 shown in the drawing) that is intended to be affirmed.

Further, the collection part 101 may collect the data DT of the disclosure object that the user once authorizes using the usage condition acquisition part 106, which will be described below, without inquiring the user in principle after that, output a sound “This is the data DT of the type allowed last time, is a collection of the data DT affirmed?” or the like generated by the agent controller 104 in timing when the data DT of the disclosure object that was once authorized by the user is collected, and collect the data DT according to the result of a simpler inquiry than the previous one (for example, when the user's response is positive). Accordingly, the data management device 10 can collect the data DT without making the user feel annoyed.

FIG. 9 is a figure showing an example of content of the data DT collected by the collection part 101 on the basis of the conversation between the agent and the user. The collection part 101 collects the data DT, in which the category is “meal information” and the content of the data are evaluation information such as “∘∘ restaurant ΔΔ was delicious” or the like when the user's speech content interpreted by the interpretation part 103 is the content that affirms to collect the data DT.

FIG. 10 is a figure showing an example of content of predetermined regulation information 121a set to classify the data DT, a category of which is “meal information” into the data group G1. In the predetermined regulation information 121a of FIG. 10, the category of “meal information” is associated with the data group G1d. The data classification part 102 classifies the data DT collected by the collection part 101 into the data group G1d, and stores the data DT in the database DB (not shown) corresponding to the data group G1g.

### [When User's Emotion is Collected as Data DT]

Further, the collection part 101 may analyze the user's emotion and collect the content of the emotion that is the analysis result as the data DT on the basis of the user's tone and vocabulary, in addition to the speech content interpreted by the interpretation part 103. In addition, the collection part 101 may analyze the user's emotion and collects the content of the emotion that is the analysis result as the data DT on the basis of the user's facial expression photographed by the in-vehicle camera (not shown) installed in the vehicle V. In this case, the data classification part 102 classifies the data DT into the data group G1 and stores the data DT in the database DB corresponding to the classified data group G1 on the basis of the predetermined regulation information 121 in which “categories” indicating different emotions are associated with the data groups G1.

### [Another Realization Method of Agent]

Further, as described above, while the case in which the agent controller 104 generates a sound that speaks to the use and outputs the sound to the speaker SP on the basis of the content of the speech interpreted by the interpretation part 103 has been described, there is no limitation thereto. The agent controller 104 may generate (or select) an animation image that matches the content of the generated sound and display the image on the terminal device TM. In addition, when the data reception system 1 has an agent robot, the agent controller 104 may control the operation of the robot to perform the operation according to the content of the generated sound. The animation image or the behavior of the robot according to the content of the sound is, for example, to express the gesture of tilting the head and inquiring about a question when it is the content to inquire about a question, to express happy facial expressions or behaviors when it is positive content, and to express dissatisfied facial expressions or behaviors when it is negative content. In addition, the interpretation part 103 may acquire a user's manifestation of intention on the basis of a user's facial expression, gesture, looking, and bio information (a heart rate, a pulse, a body temperature, sweating, and the like) detected by a camera or a biosensor included in the terminal device TM, in addition to the user's speech.

### [When Privacy Level is Contained in Elements of Data DT]

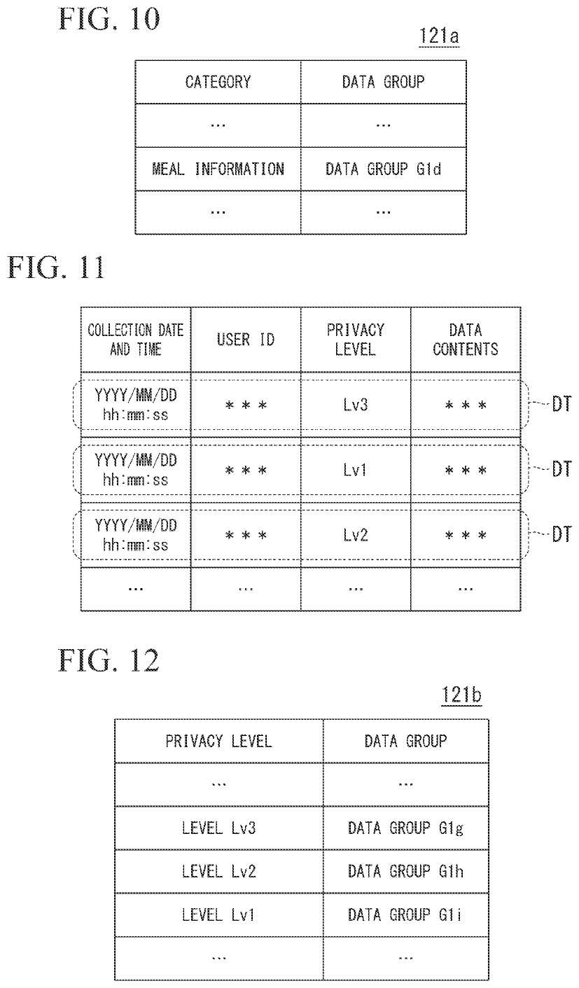

In addition, information except the category may be included in a record of the data DT. FIG. 11 is a figure showing an example of content of the data DT in which a privacy level is included as an element. The collection part 101 collects a record including, for example, a collecting date and time, a user ID, a privacy level of collected data, and data content as the data DT. The privacy level of the data DT collected by the collection part 101 is, for example, “Lv1” to “Lv3” and the like. “Lv1” is information indicating that the privacy level is lowest, and “Lv3” is information indicating that the privacy level is highest. Further, these privacy levels are only examples and are not limited thereto, and may be two levels, four levels or more or may be expressed as continuous values. The data DT, a privacy level of which is “Lv3,” is, for example, a talk, bio information, contact information, or the like, of the user, the data DT, a privacy level of which is “Lv2,” is, for example, audio information or information indicating behaviors performed by a user in the vehicle (i.e., behaviors other than behaviors related to driving (a second task)), and the data DT, a privacy level of which is “Lv1,” is, for example, driving operation information, vehicle function operation information, destination information, route retrieval history information, or the like.

FIG. 12 is a figure showing an example of content of predetermined regulation information 121b set to classify the data DT in which the privacy level is included into the data group G1. The predetermined regulation information 121b is information in which the privacy level of the data DT and the data group G1 are associated with each other. Accordingly, in the predetermined regulation indicated by the predetermined regulation information 121b, the data DT with the same privacy level is classified into the same data group G1. In the predetermined regulation information 121b of FIG. 12, the privacy level “Lv3” is associated with the data group G1g, the privacy level “Lv2” is associated with the data group G1h, and the privacy level “Lv1” is associated with the data group G1i.

The data classification part 102 classifies the data DT collected by the collection part 101 into the data group G1 corresponding to the information indicating the privacy level included in the data DT. Accordingly, the data classification part 102 can collectively store the data DT with which the privacy level coincides in the same database DB.

### [When Attribute is Included in Elements of Data DT]

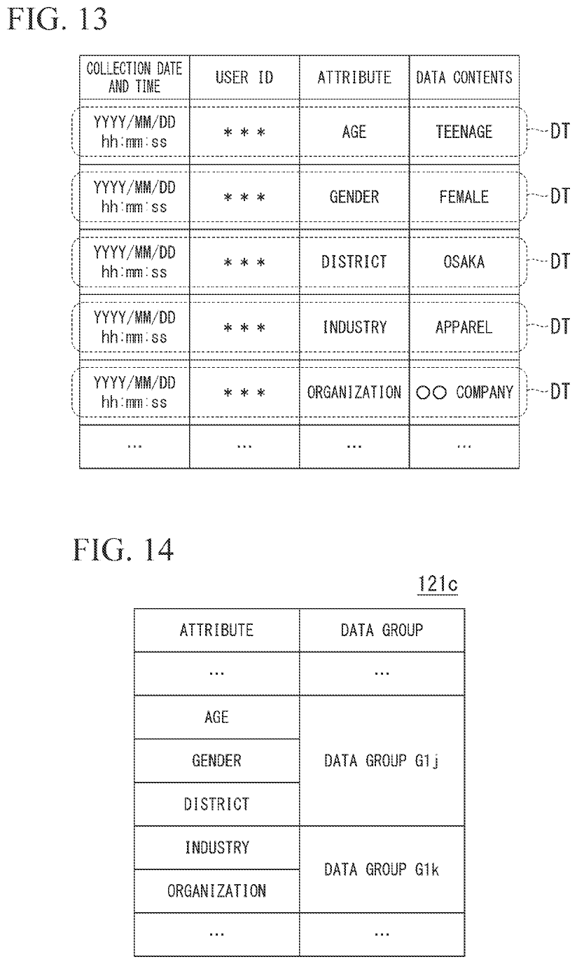

In addition, information except the category or the privacy level may be included in the record of the data DT. FIG. 13 is a figure showing an example of content of the data DT in which the user's attribute is included as an element. The collection part 101 collects the record including, for example, a collecting date and time, a user ID, a user's attribute, and data content as the data DT. The user's attribute included in the data DT is, for example, “an age,” “a gender,” “a district,” “an industry type,” “an organization,” or the like. “The district” is information indicating a district where a user is present, “the industry type” is information indicating an industry type of a user's occupation, and “the organization” is information indicating an organization (for example, an enterprise) to which the user belongs. Further, these attributes are examples and not limited thereto, and when the attributes are the user's attributes, the attribute different from these (for example, “a hobby,” “taste,” “graduated school,” “a birthplace,” “a date of birth,” “constellation,” “body height,” “a body weight,” and the like) may be included.

The data classification part 102 classifies the data DT acquired by the collection part 101 into each of the data groups G1 on the basis of predetermined regulation information 121c indicating predetermined regulation. FIG. 14 is a figure showing an example of content of the predetermined regulation information 121c set to classify the data DT in which the attribute is included into the data group G1. The predetermined regulation information 121c is information in which the attribute of the data DT and the data group G1 are associated with each other. Accordingly, in the predetermined regulation indicated by the predetermined regulation information 121c, the data DT of the same attribute is classified into the same data group G1. In the predetermined regulation information 121c of FIG. 14, the attributes of “the age,” “the gender” and “the district” are associated with the data group G1j, and the attributes of “the industry type” and “the organization” are associated with the data group G1k. For this reason, the data classification part 102 classifies the data DT with the attributes of “the age,” “the gender” and “the district” into the data group G1j, and classifies the data DT with the attributes of “the industry type” and “the organization” into the data group G1k.

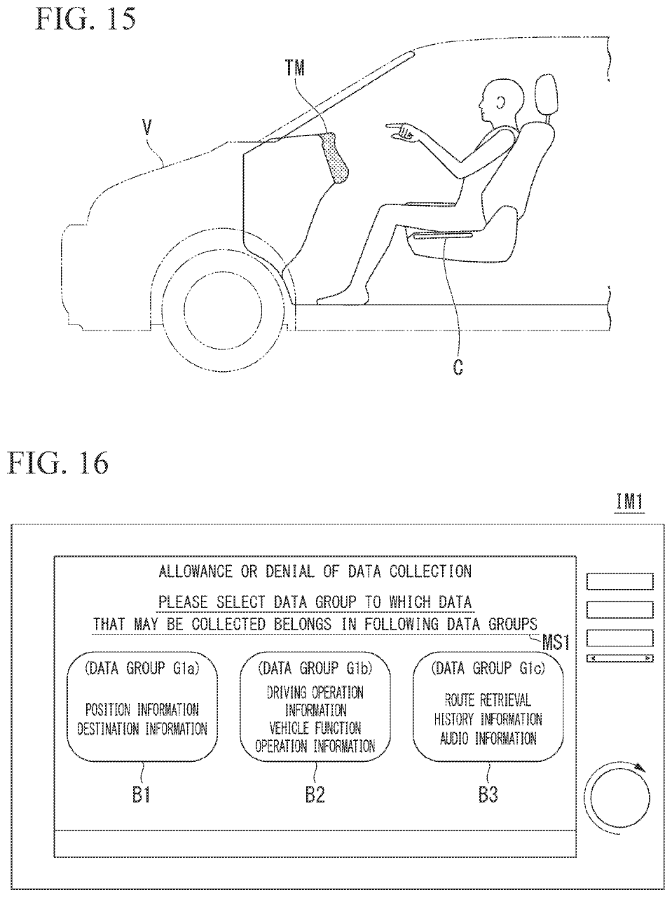

The disclosure candidate notification part 105 provides candidates for the usage condition of the data DT for each data group G1 in the terminal device TM1 to the user. In addition, the usage condition acquisition part 106 acquires the usage condition selected by the user as the candidates for the usage condition of the data DT are provided by the disclosure candidate notification part 105. FIG. 15 is a figure showing an example of a seating sensor C included in the vehicle V. For example, the seating sensor C is provided in a seat of the vehicle V. The usage condition acquisition part 106 provides the candidates for the usage condition of the data DT belonging to the data group G1 in the terminal device TM1 when it is detected by the seating sensor C that the user is in the vehicle V. The usage condition is a condition, for example, whether collection of the data DT is allowed or not, whether disclosure of the data DT is allowed or not, a disclosure recipient to whom the data DT is disclosed, a disclosure range of the data DT, a disclosure period of the data DT, or the like. The seating sensor C is an example of “the detector.” Further, the presence or absence of the user's boarding may be detected on the basis of an image captured by the in-vehicle camera, a communication state with a user's smart key and the vehicle V, a door opening signal of the vehicle V, or the like, instead of (or in addition to) the seating sensor C.

FIG. 16 is a figure showing an example of an image IM1 displayed on the terminal device TM1. The terminal device TM1 includes, for example, a touch panel that enables both of data input and data provision, and the usage condition acquisition part 106 provides the image IM1 to the terminal device TM1 when it is detected that the user is an occupant in the vehicle V. As shown in FIG. 16, the image IM1 shows “please select a data group to which data that may be collected belongs in the following data groups” that is a message of inquiring the user whether collection of the data DT is permitted or not (a message MS1 shown in the drawing), and buttons (buttons B1 to B3 shown in the drawing) that select the data groups G1. The user selects a button B corresponding to the data group G1 to which the data DT that is allowed to be collected belongs among the buttons B1 to B3 included in the image IM1 provided on the terminal device TM1. Further, the user may not select any of the buttons B when the user wishes that none of the data DT is collected. In addition, the server device SV discards the data DT, collection of which is not permitted by the user. Accordingly, the fact that the data reception system 1 does not collect the data DT from the user includes not to collect the data DT from the terminal device TM and the management device DM, and to cause the server device SV to collect the data DT temporary and immediately destroy the collected data DT. Further, the operation by the button B is an example, and the user may operate the terminal device TM using a sound command and a gesture command.

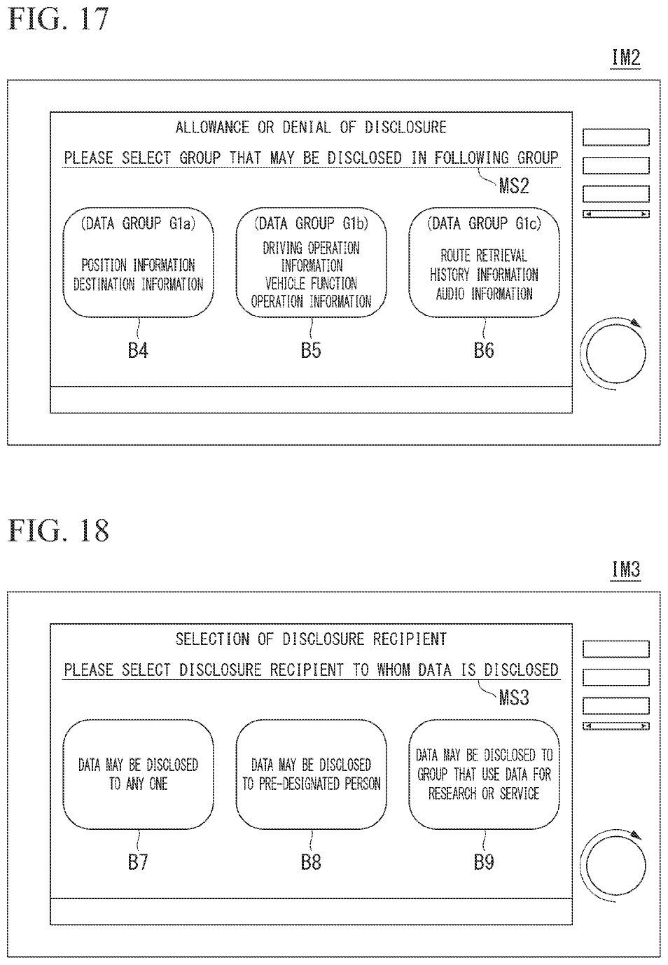

FIG. 17 is a figure showing an example of an image IM2 displayed on the terminal device TM1. The image IM2 is an image displayed on the terminal device TM1 by the usage condition acquisition part 106 after the user selects the button B corresponding to the data group G1 that may be collected on the basis of the image IM1. Regarding the data group G1 to which the data DT, collection of which is allowed, belongs, the image IM2 shows “please select the data group that may be disclosed among the following data groups” that is a message of inquiring the user whether disclosure to the disclosure recipient is allowed or not (a message MS2 shown in the drawing) and buttons (buttons B4 to B6 shown in the drawing) that selects the data groups G1. The data group G1 indicated by the button B included in the image IM2 is the data group G1, collection of which is allowed, in the image IM1. The user selects the button B corresponding to the data group G1, to which the data DT that is allowed to be disclosed belongs, among the buttons B4 to B6 included in the image IM2 provided on the terminal device TM1. Further, the user may not select any of the buttons B when the user wishes that no data DT is to be disclosed.

FIG. 18 is a figure showing an example of an image IM3 displayed on the terminal device TM1. The image IM3 is an image displayed on the terminal device TM1 by the usage condition acquisition part 106 after the user selects the button B corresponding to the data group G1 that is allowed to be disclosed on the basis of the image IM2. The image IM3 shows “please select a disclosure recipient to whom data is disclosed” (a message MS3 shown in the drawing) that is a message of inquiring the user about the disclosure recipient of the data group G1, to which the data DT, disclosure of which is allowed, belongs, and buttons (buttons B7 to B9 shown in the drawing) that selects the disclosure recipients. The button B7 is a button B selected when a disclosure recipient of the data DT is not limited (i.e., the data DT may be disclosed to anyone), the button B8 is a button B selected when the user discloses the data DT to a pre-designated person, and the button B9 is a button B selected when the data DT is disclosed to a research institute or a group using the data DT for a service. The pre-designated person is, for example, a user's relatives, or an enterprise or a group selected by the user. The usage condition acquisition part 106 displays the image IM3 of each of the data groups G1 that is selected to disclose the data DT using the image IM2 on the terminal device TM1, and acquires the disclosure recipient for each of the data groups G1.

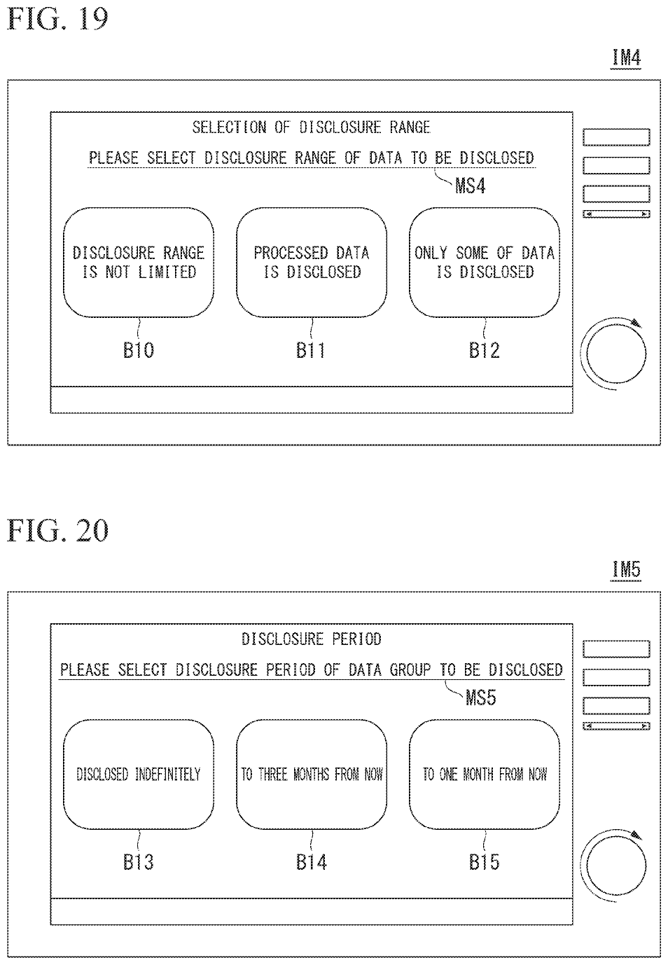

FIG. 19 is a figure showing an example of an image IM4 displayed on the terminal device TM1. The image IM4 is an image displayed on the terminal device TM1 by the usage condition acquisition part 106 after the user selects the button B corresponding to the disclosure recipient to whom the data DT is disclosed on the basis of the image IM3. The image IM4 shows “please select a disclosure range of data to be disclosed” (a message MS4 shown in the drawing) that is a message of inquiring the user about the disclosure range of the data DT with respect to the disclosure recipient, and buttons (buttons B10 to B12 shown in the drawing) that selects a disclosure range. The button B10 is a button B selected when a disclosure range of the data DT is not limited (i.e., the collected data DT is disclosed to the disclosure recipient as it is), the button B11 is a button B selected when the processed data DT is disclosed to the disclosure recipient, and the button B12 is a button B selected when only some of the data DT is disclosed to the disclosure recipient. The usage condition acquisition part 106 displays the image IM4 of each selected disclosure recipient to whom the data DT is disclosed by the image IM3 on the terminal device TM1, and acquires the disclosure range of each disclosure recipient.

FIG. 20 is a figure showing an example of an image IM5 displayed on the terminal device TM1. The image IM5 shows “please select a disclosure period of a data group to be disclosed” (a message MS5 shown in the drawing) that is a message of inquiring the user about the disclosure period of the data DT to be disclosed, and buttons (button B13 to B15 shown in the drawing) that select a disclosure period. The button B13 is a button B selected when the disclosure period of the data DT is not limited (i.e., disclosed indefinitely), the button B14 is a button B selected when the disclosure period of the data DT is limited to three months from now, and the button B15 is a button B selected when the disclosure period of the data DT is limited to one month from now. Further, choices of the disclosure period is an example and not limited thereto, the number of months which are other than three months and one month may be shown as options, and other than the number of months, the number of days and time may be shown as options. In addition, the usage condition acquisition part 106 may display the image IM5, which prompts the user to input the numerical value of the disclosure period of the data DT through the terminal device TM1. In this case, the data DT is disclosed to the disclosure recipient for the disclosure period corresponding to the numerical value input by the user.

Further, the usage condition acquisition part 106 may display the image IM on the terminal device TM to acquire a strict usage condition with respect to the data group G1 with which a high privacy level is associated (in the example, the data group G1g with which a privacy level of “Lv3” is associated) among the data DT classified by the data classification part 102. The strict usage condition is, for example, (1) limiting conditions of the disclosure recipient, (2) increasing a setting of a threshold in selection of the disclosure recipient based on the threshold of evaluation from a third party, (3) limiting a disclosure range of the data DT (to delete the data DT of a portion related to a privacy, to process the data DT and disclose the processed data as information that cannot be personally identified, or the like), (4) setting a disclosure period of the data DT to be shorter than that of the data DT of the other data group G1, (5) setting a limit to editing permission of the data DT (transmission of the data DT is not allowed, only reading on the data DT is allowed, editing of the data DT is not allowed, or the like), and the like. The usage condition acquisition part 106 provides the image IM, to which some or all of (1) to (5) are applied, on the terminal device TM with respect to the data group G1g, with which a privacy level of “Lv3” is associated, among the data DT classified by the data classification part 102. Accordingly, the usage condition setting part 107, which will be described below, can set the strict usage condition with respect to the data group G1, with which a high privacy level is associated (in the example, the data group G1g, with which a privacy level of “Lv3” is associated).

In addition, as described above, while the case in which the usage condition acquisition part 106 displays each image IM on the terminal device TM1 has been described, there is no limitation thereto. The image IM may be displayed on, for example, a user's terminal device TM2. In this case, the usage condition acquisition part 106 communicates with the terminal device TM2 via the terminal device TM1 using a cellular network, a Wi-Fi network, Bluetooth, or the like, and displays various images when it is detected by the seating sensor C that the user is in the vehicle V. In addition, in this case, various inputs may be performed using the terminal device TM2.

In addition, the collection part 101 may collect the data DT stored in a storage device (not shown) of the terminal device TM at the timing when the detection result of the seating sensor C indicates that the user is not in the vehicle V. Accordingly, the collection part 101 can suppress the communication related to the collection of the data DT from interfering with other communication of the user. In addition, the data DT may include vehicle information related to the inside and the outside of the vehicle V.

The vehicle information is, for example, an air temperature inside and outside the vehicle, weather, an image obtained by capturing the outside of the vehicle, an image obtained by capturing the inside of the vehicle, or the like. The vehicle information is an example of “moving body information.”

In addition, the usage condition acquisition part 106 may acquire a usage condition of the data DT through conversation with the user. In this case, the usage condition acquisition part 106 acquires the usage condition of the data DT by generating various speeches of inquiring about the usage condition of the data DT using the agent controller 104 and interpreting the user's speech with respect to the speech generated by the agent controller 104 using the interpretation part 103. Further, the usage condition acquisition part 106 may modify the usage condition of the data DT by interpreting the user's speech with respect to the speech generated by the agent controller 104 from a sound of supplement information indicating “This is the data that was used as the previous disclosure object. If you want to cancel the disclosure, please give us new instructions.” using the interpretation part 103 at the timing when the data DT previously set to the disclosure object is acquired.

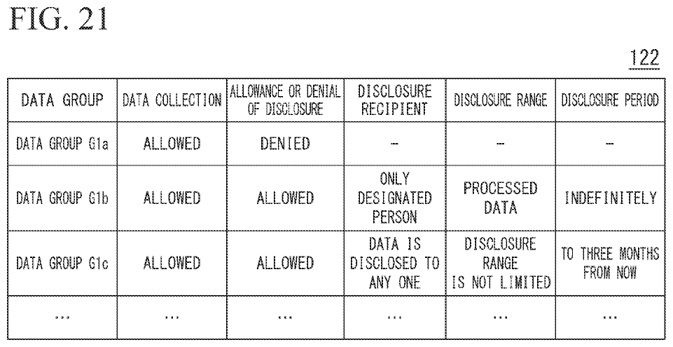

The usage condition setting part 107 sets the usage condition related to one or more data DT classified into each of the data groups G1 by the data classification part 102 to each of the data groups G1. The usage condition setting part 107 generates the usage condition information 122 on the basis of each usage condition inquired by the usage condition acquisition part 106. FIG. 21 is a figure showing an example of content of the usage condition information 122. The usage condition information 122 is information in which the data group G1, allowance or denial of collection of the data DT belonging to the data group G1, allowance or denial of disclosure of the data DT, a disclosure range of the data DT, and a disclosure time of the data DT are associated with each other.

Further, the usage condition setting part 107 may notify the user of the terminal device TM that the data DT, disclosure of which is allowed but a usage condition of which is not set, may be provided to the service provider. The notification may include a data fee for use calculated by the price calculation part 110, which will be described below. In addition, the usage condition acquisition part 106 may newly acquire the usage condition input to the terminal device TM by the user in reaction of the prompt of this notification.

In addition, the usage condition setting part 107 may set a notification to the user as the usage condition, each time a discloser uses the data DT, with respect to the data DT belonging to the data group G1, with which a high privacy level is associated. Performing a notification to the user for each time the discloser uses the data DT is an example of “making the usage condition of the data DT strict.”

The extraction part 108 extracts the data DT, the processed data DT, or some of the data DT from the server device SV for each disclosure recipient from the data DT classified into each of the data groups G1 on the basis of the usage condition information 122 set (generated) by the usage condition setting part 107.

The providing part 109 provides (discloses) the data DT extracted by the extraction part 108, the processed data DT, or some of the data DT to the disclosure recipient. For example, the providing part 109 may provide the data DT by transmitting the data DT to the disclosure recipient via a network, store the data DT in a storage medium, and provide the data DT by sending the storage medium to the disclosure recipient.

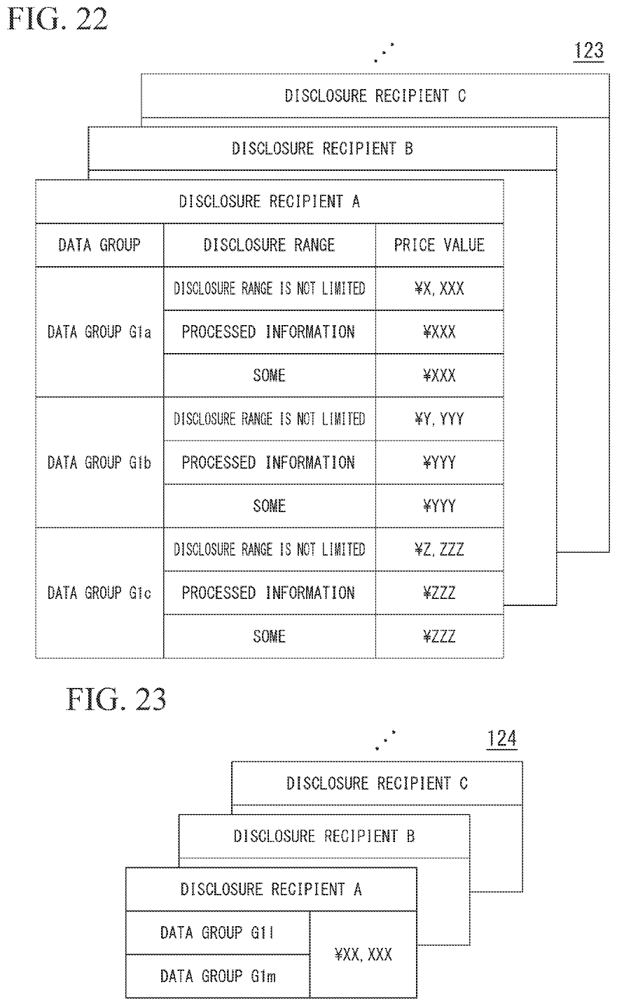

The price calculation part 110 calculates a price paid to a user by the service provider as a data using fee with respect to the data DT disclosed by the user on the basis of the usage condition information 122 set by the usage condition setting part 107. FIG. 22 is a figure showing an example of content of the price information 123. The price information 123 is information in which the data group G1, a disclosure range of the data DT belonging to the data group G1, and a price value are associated with each disclosure recipient. The price calculation part 110 calculates a price paid to the user when the data DT is provided to a certain disclosure recipient on the basis of the usage condition information 122 and the price information 123.

In addition, the price calculation part 110 calculates a price on the basis of a degree of rarity applied to the data DT in advance or a degree of demand applied to the data DT in advance. FIG. 23 is a figure showing an example of content of the rare data information 124. The rare data information 124 is information in which the data group G1 and a price value when the data DT belonging to the data group G1 is disclosed are associated with each disclosure recipient. For example, when a degree of rarity of the data DT is high (i.e., the same data DT is not well disclosed), the price value of the data group G1 to which the data DT belongs is high. In addition, when the degree of demand is high (i.e., there is the data DT that more disclosure recipients want to disclose), the price value of the data group G1 to which the data DT belongs is high. The price calculation part 110 calculates a price paid to the user from the service provider when the user provides the data DT to a certain disclosure recipient on the basis of the usage condition information 122 and the rare data information 124.

In addition, the price calculation part 110 may increase a price related to the disclosure of the data to be higher than that of the data DT to which the other data group G1 belongs with respect to the data DT belonging to the data group G1 with which a high privacy level is associated. An increase in price is an example of “making the usage condition of the data DT strict.”

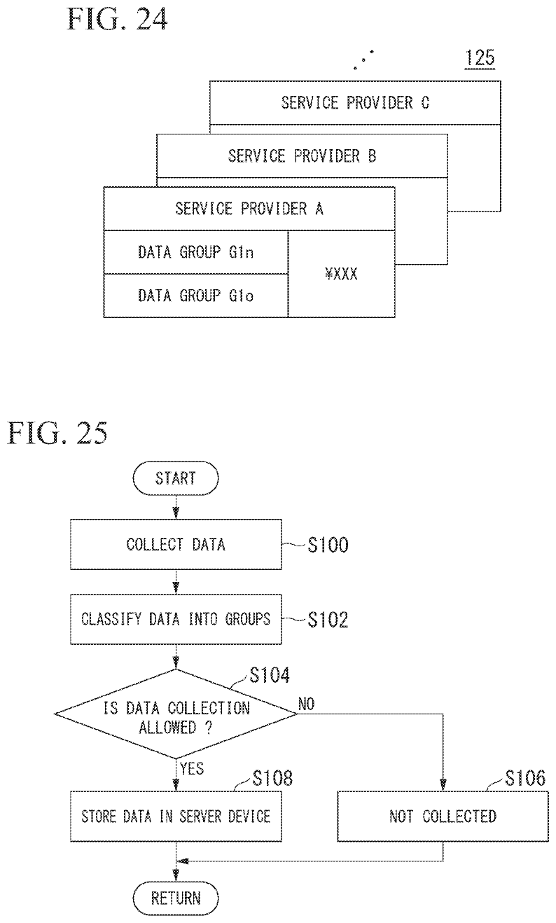

The management cost calculation part 111 calculates data management cost paid to the service provider by the user, with respect to the data DT that is collected but not to be disclosed, on the basis of the usage condition information 122 set by the usage condition setting part 107. FIG. 24 is a figure showing an example of content of the management cost information 125. The management cost information 125 is information in which the data group G1 and data management cost when the data DT belonging to the data group G1 is managed are associated with each service provider. The management cost calculation part 111 calculates data management cost paid to the service provider from the user when the data DT not disclosed by a certain service provider is managed on the basis of the usage condition information 122 and the management cost information 125.

The payment processing part 112 performs processing of causing the service provider to pay the price calculated by the price calculation part 110 to the user. The payment processing part 112 performs processing of claiming a price to the service provider by sending information indicating the price calculated by the price calculation part 110 to the terminal device provided in the payment agency service provider. In addition, the payment processing part 112 performs processing of paying the price collected from the service provider by the payment agency service provider to the corresponding user. In addition, the payment processing part 112 performs processing of sending information indicating data management cost calculated by the management cost calculation part 111 to the terminal device provided in the payment agency service provider and claiming the data management cost to the user. In addition, the payment processing part 112 performs processing of paying data management cost collected from the user by the payment agency service provider to the corresponding service provider.

Further, the payment processing part 112 may perform payment processing using money, coupon, points and other articles as a price. In addition, the payment processing part 112 may perform processing of cancelling or reducing data management cost to perform management such that the user does not disclose his/her information as a price for disclosure of information.

### [Operation Flow: Data Collection Processing]

FIG. 25 is a flowchart showing an example of a flow of a series of operations of collecting the data DT. The collection part 101 collects the data DT from the terminal device TM or the management device DM (step S100). The collection part 101 classifies the collected the data DT into the data group G1 on the basis of the predetermined regulation information 121 (step S102). The data classification part 102 determines whether collection of the data DT is allowed with respect to the data group G1 to which the data DT collected by the collection part 101 belongs on the basis of the usage condition information 122 (step S104). The data classification part 102 collects (i.e., discards) the data DT when collection of the data DT is not allowed with respect to the data group G1 to which the data DT collected by the collection part 101 belongs (step S106). The data classification part 102 collects the data DT when collection of the data DT is allowed with respect to the data group G1 to which the data DT collected by the collection part 101 belongs, and stores the collected data in the database DB of each of the data groups G1 of the server device SV (step S108).

### [Operation Flow: Generation Processing of Usage Condition Information 122]

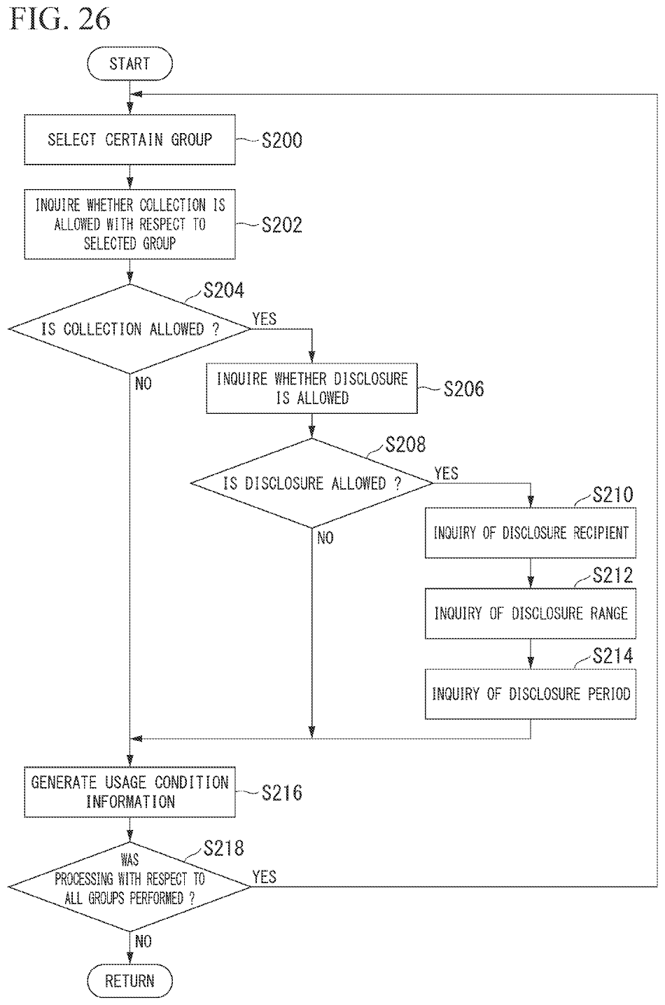

FIG. 26 is a flowchart showing an example of a flow of a series of operations of generating the usage condition information 122. The usage condition acquisition part 106 selects the data group G1 (step S200). The usage condition acquisition part 106 inquires the user whether collection of the data DT is allowed or not with respect to the data DT belonging to the selected data group G1 (step S202). The usage condition acquisition part 106 inquires the user whether collection of the data DT is allowed or not by displaying the image IM1 on the terminal device TM or the user's terminal device or by a conversation with the user performed by the interpretation part 103 and the agent controller 104.

The usage condition acquisition part 106 determines whether collection of the data DT belonging to the selected data group G1 is allowed by the user through the inquiry (step S204). The usage condition acquisition part 106 advances the processing to step S216 when collection of the data DT belonging to the selected data group G1 is not allowed by the user through inquiry. The usage condition acquisition part 106 inquires the user whether disclosure of the data DT belonging to the selected data group G1 is allowed or not when collection of the data DT belonging to the selected data group G1 is allowed by the user through inquiry (step S206). The usage condition acquisition part 106 advances the processing to step S216 when disclosure of the data DT belonging to the selected data group G1 is not allowed by the user through inquiry. The usage condition acquisition part 106 inquires the user about the disclosure recipient of the data DT belonging to the selected data group G1 when disclosure of the data DT belonging to the selected data group G1 is allowed by the user through inquiry (step S210). Next, the usage condition acquisition part 106 inquires the user about the disclosure range of the data DT belonging to the selected data group G1 (step S212). Next, the usage condition acquisition part 106 inquires the user about the disclosure period of the data DT belonging to the selected data group G1 (step S214).

The usage condition setting part 107 generates the usage condition information 122 on the basis of the usage condition acquired through inquiry of the usage condition acquisition part 106 (whether collection of the data DT is allowed or not, whether disclosure of the data DT is allowed or not, a disclosure recipient to whom the data DT is disclosed, a disclosure range of the data DT, or a disclosure period of the data DT) (step S216). The usage condition acquisition part 106 repeats processing of steps S200 to S216 until the above-mentioned processing with respect to the data group G1 is entirely performed (step S218).

### [Operation Flow: Provision Processing of Data DT]

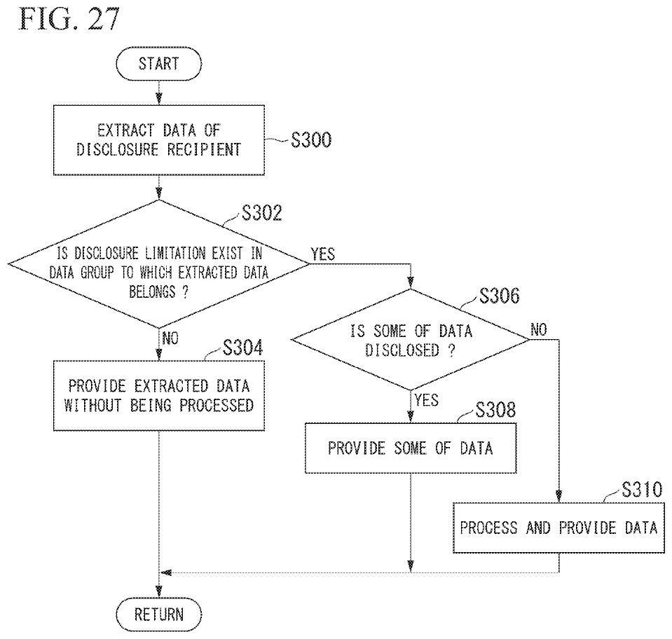

FIG. 27 is a flowchart showing an example of a flow of a series of operations of providing the data DT to the disclosure recipient. Processing of the flowchart shown in FIG. 27 is processing performed for each disclosure recipient. The extraction part 108 extracts the data provided to a certain disclosure recipient from the server device SV on the basis of the usage condition information 122 (step S300). The providing part 109 determines whether a disclosure limitation is present in the data group G1 to which the data DT extracted by the extraction part 108 belongs (step S302). The providing part 109 provides the data DT belonging to the data group G1 to the disclosure recipient without being processed when it is determined that the disclosure limitation is not present in the data group G1 (step S304). The providing part 109 determines whether the disclosure limitation discloses some of the data DT when it is determined that the disclosure limitation is present in the data group G1 (step S306). The providing part 109 provides some of the data DT belonging to the data group G1 to the disclosure recipient when the disclosure limitation is to disclose some of the data DT (step S308). The providing part 109 processes the data DT and provides the data DT to the disclosure recipient when the disclosure limitation is not to disclose some of the data DT (step S310).

### [Operation Flow: Payment Processing Related to Data DT]

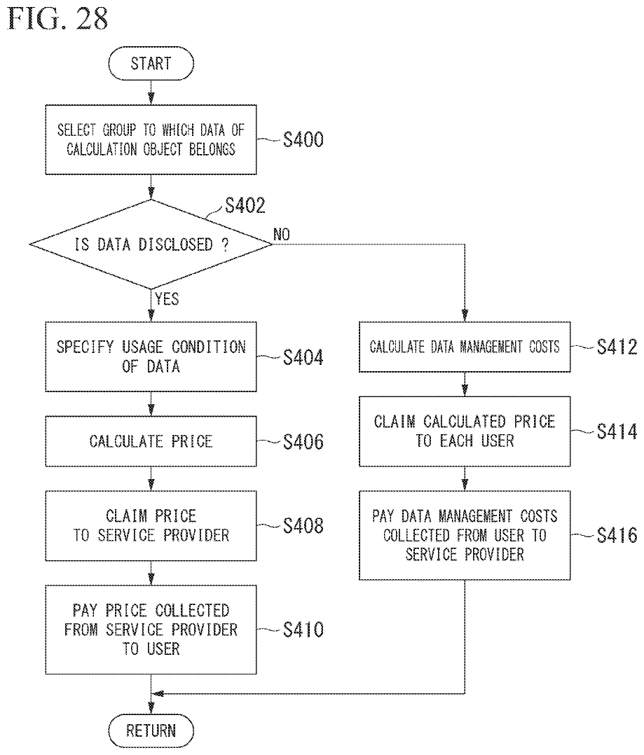

FIG. 28 is a flowchart showing an example of a flow of a series of operations of payment processing related to the data DT. The processing of the flowchart shown in FIG. 28 is processing performed for each disclosure recipient. The price calculation part 110 selects the data group G1 to which the data DT of the object, a price or data management cost of which is calculated, belongs (step S400). The price calculation part 110 determines whether disclosure of the data DT belonging to the selected data group G1 is allowed or not (step S402). The price calculation part 110 specifies the usage condition of the data DT belonging to the selected data group G1 on the basis of the usage condition information 122 when disclosure of the data DT belonging to the selected data group G1 is allowed (step S404). The price calculation part 110 calculates a price paid to the user by the service provider on the basis of the specified usage condition, the price information 123, and the rare data information 124 (step S406). The payment processing part 112 claims the price calculated by the price calculation part 110 to the service provider (step S408). The payment processing part 112 pays the price collected from the service provider to the user to whom the data DT is disclosed (step S410).

The management cost calculation part 111 calculates data management cost paid to the service provider by the user on the basis of the management cost information 125 when disclosure of the data DT belonging to the selected data group G1 is not allowed (step S412). The payment processing part 112 claims the data management cost calculated by the management cost calculation part 111 to the user (step S414). The payment processing part 112 pays the data management cost collected from the user to the service provider that manages (stores) the data (step S416).

### [Summarize of Data Management Device 10]

As described above, the data management device 10 of the embodiment includes the collection part 101 configured to collect the data of the user from the user's terminal device TM or the management device DM of the service provider that provides information to the user, the data classification part 102 configured to classify the data DT of the user that is the object collected by the collection part 101 into the data group G1 on the basis of the predetermined regulation information 121, the usage condition setting part 107 configured to set of one or more pieces of the usage condition information 122 of the data DT classified into the data group G1 by the data classification part 102 for each of the data groups G1, and the providing part 109 configured to provide the data DT to the outside (in the example, the disclosure recipient) on the basis of the usage condition information 122 for each of the data groups G1 set by the usage condition setting part 107, and thus, it is possible to obtain from the user use permission of the data DT collected from the user while reducing the time and effort of the user.

Further, in the above-mentioned description, while the case in which the vehicle V is used only by a specified user (for example, an owner of the vehicle V) and the data DT belongs to the owner of the vehicle V has been described, there is not limitation thereto. For example, when the vehicle V is a ride-share vehicle, the owner of the vehicle V may be different from the user whose collection part 101 collects the data DT. In this case, the collection part 101 notifies the user in the vehicle V except the owner of the vehicle V (hereinafter, a non-owner user) with a speech “the data DT collected in use of the vehicle V belongs to the owner of the vehicle V and the owner of the vehicle V may provide the collected data DT to the service provider” generated by the terminal device TM or the agent controller 104. The collection part 101 collects the data DT acquired from the non-owner user only when the non-owner user approves the notification. In other words, the collection part 101 discards the acquired data DT when the non-owner user does not approve of the notification. Further, the data classification part 102, the interpretation part 103, the agent controller 104, the disclosure candidate notification part 105, the usage condition acquisition part 106, and the usage condition setting part 107 may perform the above-mentioned processing with respect to the non-owner user, and set the usage condition of the data DT related to the non-owner user.

### [With Respect to Data Disclosure Device 20]

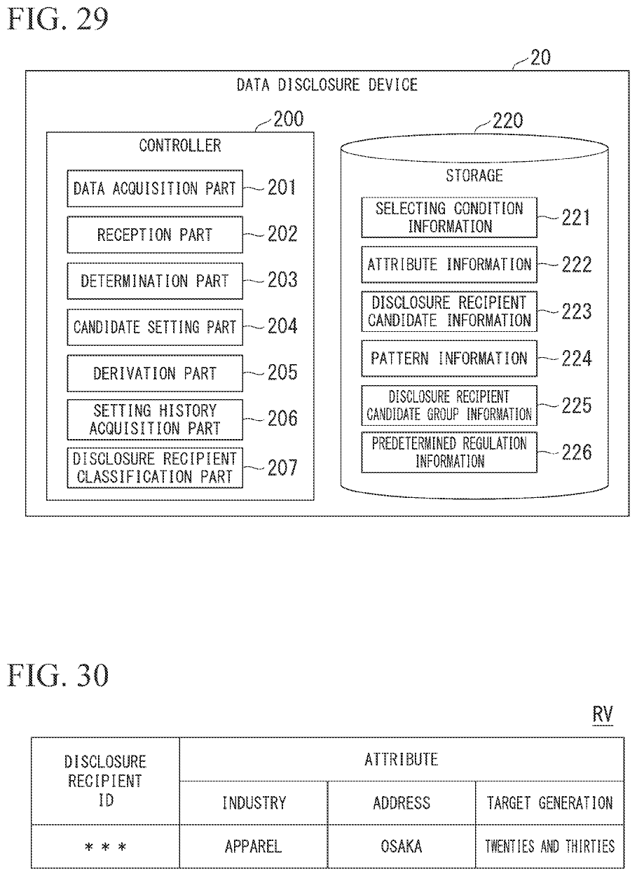

Hereinafter, the data disclosure device 20 will be described. The data disclosure device 20 is a device configured to recommend to the user candidates for the disclosure recipient who actually receives the data DT among the data acquisition desiring applicants who wish to receive the data DT, disclosure of which is allowed by the user. FIG. 29 is a figure showing an example of a configuration of the data disclosure device 20 according to the embodiment. The data disclosure device 20 includes a controller 200 and a storage 220. The controller 200 realizes function units of a data acquisition part 201, a reception part 202, a determination part 203, a candidate setting part 204, a derivation part 205, a setting history acquisition part 206 and a disclosure recipient classification part 207 by executing a program stored in the storage 220 using a hardware processor such as a CPU or the like. In addition, some or all of these components may be realized by hardware (a circuit part; including circuitry) such as LSI, ASIC, FPGA, GPU, or the like, and may be realized by cooperation of software and hardware.

### [With Respect to Storage 220]

For example, the storage 220 may be realized by a storage device such as an HDD, a flash memory, or the like, may be realized by a detachable storage medium such as a DVD, a CD-ROM, or the like, or may be a storage medium mounted on a drive device. In addition, a part or the entirety of the storage 220 may be an accessible external device of the data disclosure device 20 such as NAS, an external storage server, or the like. The storage 220 stores, for example, selecting condition information 221, attribute information 222, disclosure recipient candidate information 223, pattern information 224, disclosure recipient candidate group information 225, and predetermined regulation information 226. Details of various pieces of information will be described below.

### [With Respect to Data Acquisition Part 201]

The data acquisition part 201 acquires the data DT of the processing target related to setting processing of the candidates for the disclosure recipient, which is the data DT, disclosure of which is allowed by the user, among the data DT stored in the server device SV.

### [With Respect to Reception Part 202]

The reception part 202 receives information indicating request of disclosure of the data DT (hereinafter, request information RV) from the disclosure recipient who wants to disclose the data DT acquired by the data acquisition part 201. The reception part 202 may receive, for example, the request information RV according to acquisition of the data DT of the processing target by the data acquisition part 201, and may have a configuration in which the request information RV of each data DT is normally received, the received request information RV is stored in the storage 220, and the request information RV with respect to the data DT is read from the storage 220 as the data DT of the processing target is acquired by the data acquisition part 201.

FIG. 30 is a figure showing an example of content of the request information RV. The request information RV is, for example, information in which information that enables identification of a data acquisition desiring applicant who receives the request information RV by the reception part 202 (hereinafter, a data acquisition desiring applicant ID) and information indicating an attribute of the data acquisition desiring applicant are associated with each other. The attribute of the data acquisition desiring applicant is information indicating, for example, “an industry type” of the data acquisition desiring applicant, “address” of the data acquisition desiring applicant, a generation in which the data acquisition desiring applicant requests the data DT (hereinafter, a target generation).

Further, the attribute of the data acquisition desiring applicant is an example but not limited thereto, and may include information different from these (for example, “goods” sold by the data acquisition desiring applicant, “a capital,” “an employee number,” “a catchphrase,” or the like. In addition, as the attribute of the data acquisition desiring applicant, evaluation information of the data acquisition desiring applicant by another user, or evaluation information of the data acquisition desiring applicant which is acquired through a process (technique) other than the process related to the data management device 10 or the data disclosure device 20 may be included.

### [With Respect to Determination Part 203]

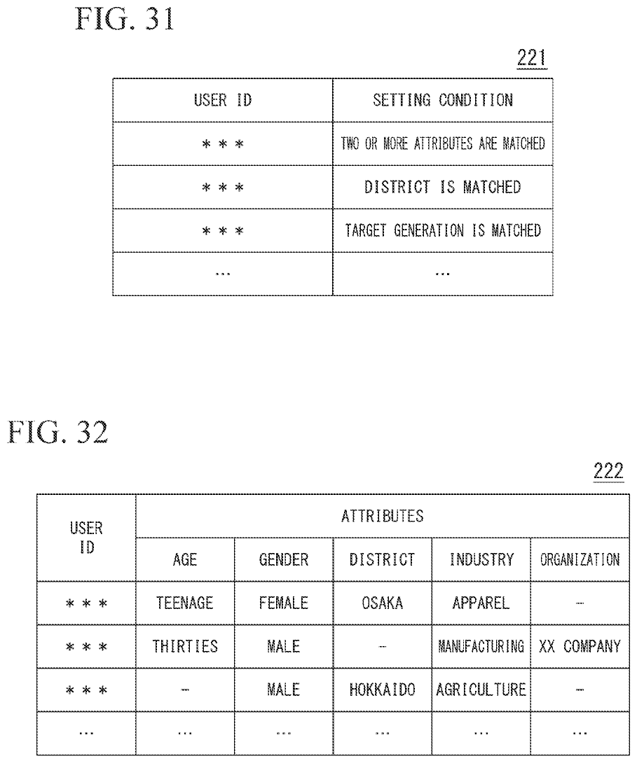

The determination part 203 determines whether the data acquisition desiring applicant who received the request information RV by the reception part 202 matches the selecting condition that is the condition in which the user selects the disclosure recipient. FIG. 31 is a figure showing an example of content of the selecting condition information 221. The selecting condition information 221 is information in which the user ID is associated with the selecting condition in which the user indicated by the user ID selects the disclosure recipient. The selecting condition is, for example, “two or more attributes of the user and the disclosure recipient match each other,” “a district in which the user is present matches address of the disclosure recipient,” “a generation of the user matches a target generation of the disclosure recipient,” and the like. The selecting condition is, for example, previously determined. Further, the selecting condition may be determined by each user by oneself, or may be determined by the service provider or the disclosure recipient (the data acquisition desiring applicant) oneself in consideration of price or data management cost. In addition, the selecting condition may be set while referring to the selecting condition of another user. In this case, the data disclosure device 20 specifies another user (a user B) of an attribute coinciding with or similar to a certain user (a user A), and provides information indicating the selecting condition of the user B to the terminal device TM of the user A via a network. The terminal device TM of the user A displays the selecting condition of the user B received from the data disclosure device 20 on the display part. Accordingly, when the selecting condition of the disclosure recipient is set, the user A can set his/her selecting condition while referring to the selecting condition of the user B with the attribute coinciding with or similar to the user A.

The determination part 203 determines whether the data acquisition desiring applicant matches the selecting condition on the basis of, for example, the request information RV, the selecting condition information 221 and the attribute information 222. FIG. 32 is a figure showing an example of content of the attribute information 222. The attribute information 222 is information in which the user ID is associated with the user's attribute indicated by the user ID. For example, the data management device 10 may generate the attribute information 222 on the basis of the information acquired from each service provider, or may generate the attribute information 222 on the basis of the information acquired by the user in advance. The user's attribute used to generate the attribute information 222 is an attribute that is allowed in advance to be used to generate the attribute information 222 by the user. Further, the attribute information of the user may include a hobby and taste information indicating taste of an occupant.

### [With Respect to Candidate Setting Part 204]

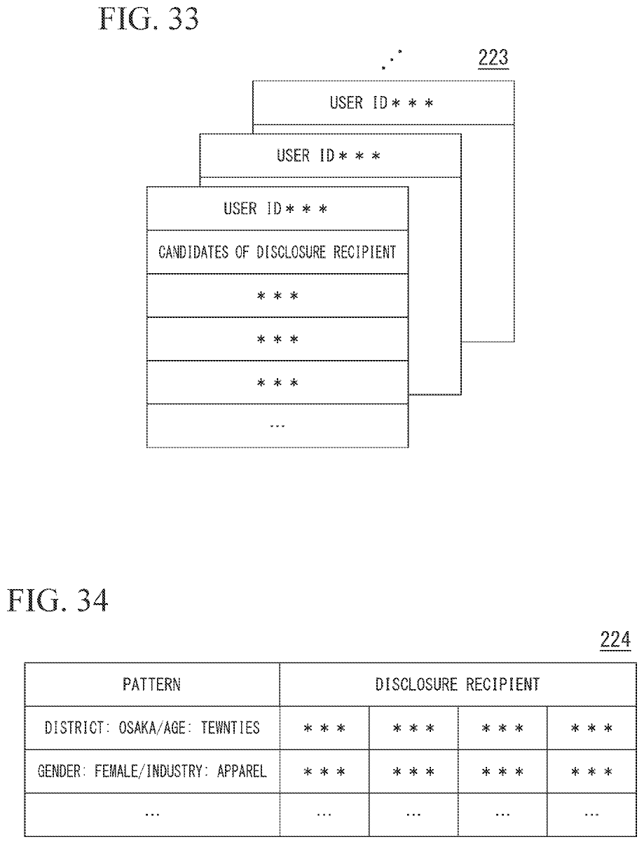

The candidate setting part 204 sets the data acquisition desiring applicant as the candidate for the disclosure recipient, for example, when the determination result of the determination part 203 indicates that the data acquisition desiring applicant matches the selecting condition. FIG. 33 is a figure showing an example of content of the disclosure recipient candidate information 223. This information is information in which the user ID and the candidate for the disclosure recipient of the user indicated by the user ID are associated with each other for each user ID. The candidate setting part 204 includes the data acquisition desiring applicant which is set as the candidate for the disclosure recipient in the disclosure recipient candidate information 223.

### [With Respect to Derivation Part 205]

Further, the candidate setting part 204 may set the candidate for the disclosure recipient on the basis of the information other than the determination result of the determination part 203. The derivation part 205 derives the information used for set processing of the candidate for the disclosure recipient by the candidate setting part 204. The derivation part 205 derives a pattern of a combination of the attribute and the disclosure recipient on the basis of the attribute information 222 and the disclosure recipient candidate information 223. FIG. 34 is a figure showing an example of content of the pattern information 224. The pattern information 224 is information in which combinations of the attributes and the disclosure recipients are associated with each other. The derivation part 205 determines whether the user is in a tendency (a pattern) that sets the same disclosure recipient by, for example, referring the disclosure recipient candidate information 223 with respect to the user having a certain attribute among the users indicated by the attribute information 222. The derivation part 205 includes correspondence between the attribute having the tendency and the disclosure recipient in the pattern information 224.

### [Regarding Addition of Candidates for Disclosure Recipient on Basis of Pattern Information 224]

The candidate setting part 204 adds the candidate for the disclosure recipient to the disclosure recipient candidate information 223 on the basis of the pattern information 224 derived by the derivation part 205 and the usage condition information 122 acquired from the data management device 10 by the setting history acquisition part 206. The candidate setting part 204 adds another disclosure recipient associated with the pattern to the disclosure recipient candidate information 223 as the candidate for the disclosure recipient of a certain user, for example, when the disclosure recipient indicated by the usage condition information 122 of the certain user matches the disclosure recipient of a certain pattern indicated by the pattern information 224.

Further, with respect to the user (the user A) who has not designated the disclosure recipient until now (i.e., the usage condition information 122 is not present), when the candidate for the disclosure recipient is added to the disclosure recipient candidate information 223, the candidate setting part 204 may add the candidate for the disclosure recipient included in the disclosure recipient candidate information 223 of the user which has a similar attribute indicated by the attribute information 222 with the above mentioned user to the disclosure recipient candidate information 223 as the candidate for the disclosure recipient with respect to the user A.

In addition, the candidate setting part 204 may add to the disclosure recipient candidate information 223 the candidate for the disclosure recipient having a high rate to be included in the disclosure recipient candidate information 223. In addition, the candidate setting part 204 may add the candidate for the disclosure recipient whose price or correspondence is highly evaluated by the user to the disclosure recipient candidate information 223.

In addition, the setting history acquisition part 206 acquires recommendation information instead of (or in addition to) the usage condition information 122, and the candidate setting part 204 may add the candidate for the disclosure recipient to the disclosure recipient candidate information 223 on the basis of the recommendation information acquired by the setting history acquisition part 206. The recommendation information is information in which the data DT indicating the disclosure recipient recommended by another user through a media or a social networking service (SNS) is associated with each user ID. In this case, for example, the data management device 10 acquires the data DT from the service provider that provides the media or the service provider that provides the SNS, generates the recommendation information by corresponding the acquired data DT and the user ID to each other, and stores the generated information in the storage 120. For example, the setting history acquisition part 206 acquires recommendation information of other users whose attribute indicated by the attribute information 222 is similar to that of the user. The candidate setting part 204 adds the disclosure recipient indicated by the recommendation information of the similar other users acquired by the setting history acquisition part 206 to the disclosure recipient candidate information 223 of the user.

### [With Respect to Disclosure Recipient Classification Part 207]

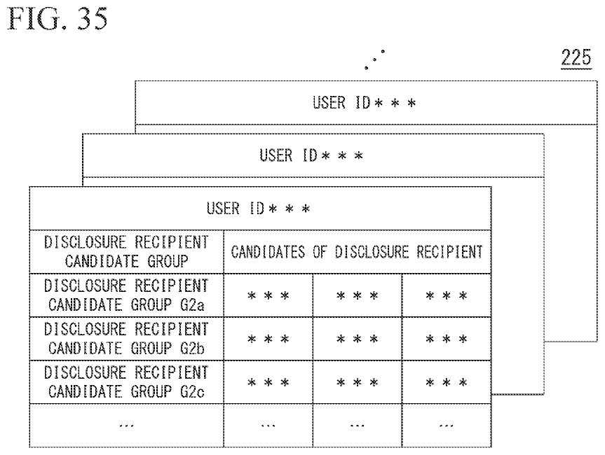

The disclosure recipient classification part 207 classifies the candidates for the plurality of disclosure recipients indicated by the disclosure recipient candidate information 223 into a group (hereinafter, a disclosure recipient candidate group G2) on the basis of predetermined regulation indicated by the predetermined regulation information 226. In the predetermined regulation, for example, the data DT, disclosure of which is allowed in the usage condition information 122, and the candidate for the disclosure recipient to which the same data DT is disclosed are classified into the same disclosure recipient candidate group G2. In addition, in the predetermined regulation, for example, the attribute of the user who discloses the data DT, and the candidate for the disclosure recipient disclosed by the user having the same attribute are classified into the same disclosure recipient candidate group G2. FIG. 35 is a figure showing an example of content of the disclosure recipient candidate group information 225. The disclosure recipient classification part 207 is information in which the disclosure recipient candidate group G2 and the candidate for the disclosure recipient belonging to the disclosure recipient candidate group G2 are associated with each other for each user ID. The disclosure recipient classification part 207 classifies the disclosure recipient into the disclosure recipient candidate group G2 on the basis of the predetermined regulation, and generates the disclosure recipient candidate group information 225. Further, the predetermined regulation may be a condition other than the attribute information of the user. For example, the disclosure recipient classification part 207 may classify the disclosure recipient into the disclosure recipient candidate group G2 on the basis of the taste information of the user. In addition, the disclosure recipient classification part 207 may classify the disclosure recipients whose attributes coincide with each other into the same disclosure recipient candidate group G2.

According to the above-mentioned processing, the disclosure recipient classification part 207 classifies user's near relatives such as “an individual designated by the user,” “user's relatives,” “a community to which the user belongs,” and the like, that are candidates for the disclosure recipient into the disclosure recipient candidate group G2a. When disclosure to the disclosure recipient candidate group G2a is allowed by the user and the disclosure period is set after the user's death, for example, the user's near relative can receive the information related to the user after the user's death. In addition, the disclosure recipient classification part 207 classifies, for example, “a social contribution group,” “a welfare group,” and the like, which are candidates for the disclosure recipient, into the disclosure recipient candidate group G2b. When disclosure to the disclosure recipient candidate group G2b is allowed by the user and the user's bio information (for example, information related to a blood type and a bone marrow liquid, presence or absence of donor registration, or the like) is included in the information of the disclosure object, the user can disclose his/her bio information to a larger number of “social contribution groups” and “welfare groups” through a simple operation. In addition, for example, the disclosure recipient classification part 207 classifies “a research institute,” “a university,” “an enterprise,” and the like, which are candidates for the disclosure recipient, into the disclosure recipient candidate group G2c. When disclosure to the disclosure recipient candidate group G2c is allowed by the user, the user can contribute to development of the technology.

### [With Respect to Provision of Candidate for Disclosure Recipient]

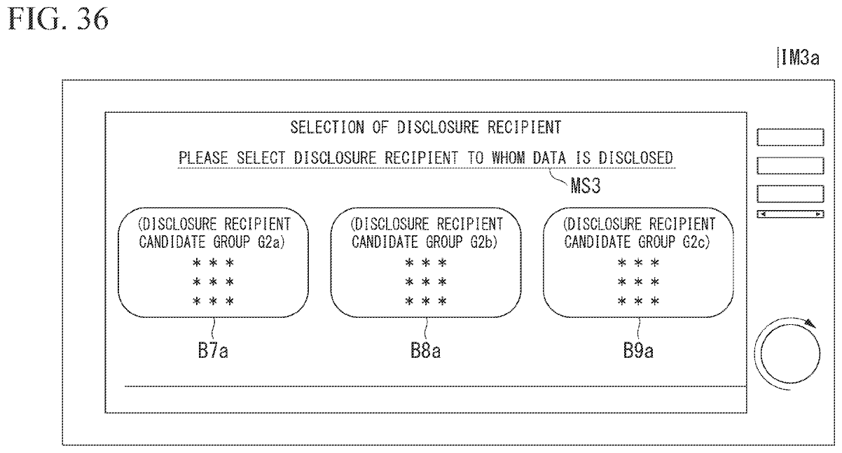

FIG. 36 is a figure showing an example of an image IM3a displayed on the terminal device TM. The image IM3a is an image generated on the basis of the disclosure recipient candidate group information 225, which is an image displayed on the terminal device TM by the usage condition acquisition part 106 after the button B corresponding the data group G1 in which the user ID may be disclosed on the basis of the image IM2 is selected. The image IM3a shows the message MS3 of inquiring the user about the candidate for the disclosure recipient belonging to the disclosure recipient candidate group G2a to G2c to which the data DT are disclosed, and buttons (buttons B7a to B9a shown in the drawing) that select candidates for each disclosure recipient. The buttons B7a to B9a are the buttons B indicating the disclosure recipient belonging to each of the disclosure recipient candidate groups G2 of the disclosure recipient candidate group information 225 for each of the disclosure recipient candidate groups G2. The usage condition acquisition part 106 displays the image IM3a of each of the data groups G1 selected to disclose the data DT by the image IM2 on the terminal device TM, and provides the larger number of candidates for the disclosure recipient with respect to a certain data group G1 to the user.

Further, the usage condition acquisition part 106 may acquire the inquiry related to allowance or denial of the disclosure of the data DT with respect to the candidate for the disclosure recipient belonging to the disclosure recipient candidate group G2 by the image IM3a (i.e., the usage condition) through conversation with the user. In this case, the usage condition acquisition part 106 acquires the usage condition of the data DT by generating various speeches of inquiring allowance or denial of the disclosure of the data DT with respect to the candidate for the disclosure recipient belonging to the disclosure recipient candidate group G2 using the agent controller 104, and by interpreting the user's speech with respect to the speech generated by the agent controller 104 using the interpretation part 103 on the basis of the disclosure recipient candidate group information 225.

In addition, the disclosure recipient candidate groups G2a to G2c are examples of classification, and there is no limitation thereto. For example, the disclosure recipient classification part 207 may classify “a service (provider)” or the like that is a candidate for the disclosure recipient as the disclosure recipient candidate group G2. Here, when the service provider receives disclosure of the information from the user, the data fee for use may be paid to the user. When disclosure to the disclosure recipient candidate group G2 is allowed by the user, the user can obtain a lot of data fee for use. In addition, the disclosure recipient classification part 207 may classify “an antisocial organization,” “a dishonest dealer,” or the like, which is the candidate for the disclosure recipient, as the disclosure recipient candidate group G2. The user can prevent abuse of his/her data DT by not allowing the disclosure to the disclosure recipient candidate group G2.

### [Operation Flow: Generation Processing of Disclosure Recipient Candidate Information 223]

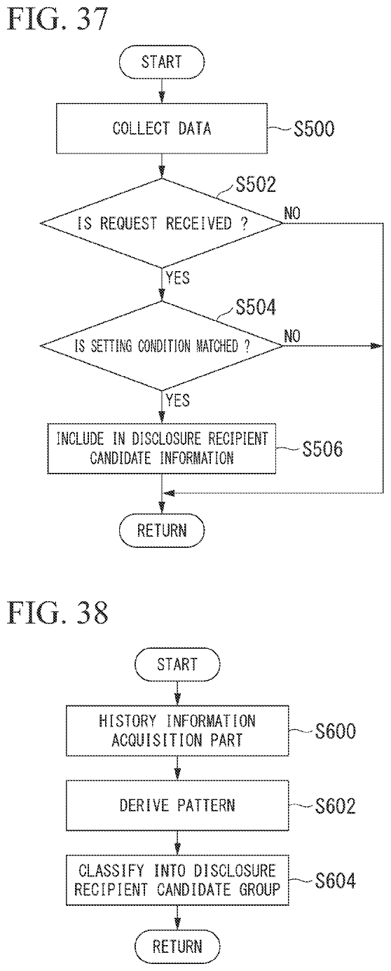

FIG. 37 is a flowchart showing an example of a flow of a series of operations of generation processing of the disclosure recipient candidate information 223. The collection part 101 acquires the data DT which is the processing target that sets the candidate for the disclosure recipient, and which is the data DT, disclosure of which is allowed by the user, among the data DT stored in the server device SV (step S500). The reception part 202 determines whether the request information RV is received from the data acquisition desiring applicant with respect to the data DT acquired by the collection part 101 (step S502). The reception part 202 terminates the processing when the request information RV is not received from the data acquisition desiring applicant. The determination part 203 determines whether the data acquisition desiring applicant matches the selecting condition indicated by the selecting condition information 221 when the request information RV is received from the data acquisition desiring applicant by the reception part 202 (step S504). The determination part 203 terminates the processing while not including the data acquisition desiring applicant in the disclosure recipient candidate information 223 when the data acquisition desiring applicant does not match the selecting condition. The candidate setting part 204 includes the data acquisition desiring applicant in the disclosure recipient candidate information 223 as the candidate for the disclosure recipient when the data acquisition desiring applicant matches the selecting condition (step S506).

### [Operation Flow: Process of Adding Candidate for Disclosure Recipient to Disclosure Recipient Candidate Information 223]

FIG. 38 is a flowchart showing an example of a flow of an operation of an example of processing which adds a candidate for a disclosure recipient to the disclosure recipient candidate information 223. The flowchart shown in FIG. 38 is processing performed for each user (the user ID). The setting history acquisition part 206 acquires the usage condition information 122 from the data management device 10 (step S600). The derivation part 205 derives a pattern of a combination of the attribute and the disclosure recipient and generates the pattern information 224 on the basis of the usage condition information 122 acquired by the setting history acquisition part 206 and the attribute information 222 (step S602). The disclosure recipient classification part 207 classifies the candidate for disclosure recipient included in the disclosure recipient candidate information 223 into the disclosure recipient candidate group G2 and generates the disclosure recipient candidate group information 225 on the basis of the predetermined regulation indicating the pattern information 224 generated by the derivation part 205 in the predetermined regulation information 226 (step S604). The usage condition acquisition part 106 provides the disclosure recipient candidate group G2 of each user generated in step S604 to the user in the above-mentioned step S210 (see FIG. 26).

### [With Respect to Provision of Disclosure Recipient Candidate Group G2]

Further, in the above-mentioned description, while the case in which the disclosure recipient candidate group G2 is provided as the disclosure recipient to whom the data DT belonging to the data group G1 selected in the image IM2 by the usage condition acquisition part 106 is disclosed has been described, there is no limitation thereto. The usage condition acquisition part 106 may have a configuration in which the disclosure recipient candidate group G2 is provided for each data DT instructed to be disclosed by the user.

### [Configuration of Data Management Device 10 and Data Disclosure Device 20]

Further, in the above-mentioned description, while the case in which the data management device 10 includes the interpretation part 103, the agent controller 104, the disclosure candidate notification part 105, the usage condition acquisition part 106, the usage condition setting part 107, the extraction part 108, the providing part 109, the price calculation part 110, and the management cost calculation part 111 has been described, there is no limitation thereto. For example, the data disclosure device 20 may include function parts thereof.

### [Summarize of Data Disclosure Device 20]

As described above, the data disclosure device 20 of the embodiment includes the data acquisition part 201 configured to acquire the data DT related to the user from the data management device 10 that manages the data of the user, the candidate setting part 204 configured to set the candidate for the disclosure recipient to whom the data DT acquired by the data acquisition part 201 is disclosed on the basis of the attribute information 222 indicating the user's attribute or the data DT, the usage condition acquisition part 106 configured to perform inquiry related to the usage condition of the data DT and acquire the usage condition of the data DT desired by the user while providing the candidate for the disclosure recipient set by the candidate setting part 204 to the user, and the usage condition setting part 107 configured to set the usage condition of the data DT on the basis of the usage condition acquired by the usage condition acquisition part 106, and thus, it is possible to provide the user with a guideline for determining the disclosure recipient.

Hereinabove, while the aspect of performing the present invention has been described using the embodiment, the present invention is not particularly limited to the embodiment, and various modifications and substitutions may be added without departing from the scope of the present invention.

### REFERENCE SIGNS LIST

1 Data reception system
10 Data management device
20 Data disclosure device
100 Controller
101 Collection part
102 Data classification part
103 Interpretation part
104 Agent controller
105 Disclosure candidate notification part
106 Usage condition acquisition part
107 Usage condition setting part
108 Extraction part
109 Providing part
110 Price calculation part
111 Management cost calculation part
112 Payment processing part
120 Storage
121 Predetermined regulation information
121a Predetermined regulation information
121b Predetermined regulation information
121c Predetermined regulation information
122 Usage condition information
123 Price information
124 Rare data information
125 Management cost information
200 Controller
201 Data acquisition part
202 Reception part
203 Determination part
204 Candidate setting part
205 Derivation part
206 Setting history acquisition part
207 Disclosure recipient classification part
220 Storage
221 Selecting condition information
222 Attribute information
223 Disclosure recipient candidate information
224 Pattern information
225 Disclosure recipient candidate group information
226 Predetermined regulation information
412 Step
DM Management device
G1, G1, G1a, G1b, G1c, G1d, G1g, G1h, G1i, G1j, G1k Data group
G2 Disclosure recipient candidate group
RV Request information
SV Server device
TM, TM1, TM2 Terminal device
V Vehicle

What is claim is:

1. A data management device comprising:
a collection part configured to collect data of a user from a terminal device of the user or a device of a service provider that provides information to the user;
a data classification part configured to classify the data of the user that is a target to be collected by the collection part into groups on the basis of a predetermined regulation;
a usage condition setting part configured to set one or more usage conditions of the data classified into the groups by the data classification part for each of the groups; and
a providing part configured to provide the data to an outside on the basis of the usage condition of each of the groups set by the usage condition setting part.

2. The data management device according to claim 1, wherein the predetermined regulation is a regulation that classifies the data into groups on the basis of a degree of privacy applied to the data in advance, and
the usage condition setting part makes the usage condition of data of a first group stricter than the usage condition of data of a second group to which data having a lower degree of privacy than the data of the first group belongs.

3. The data management device according to claim 1, wherein the predetermined regulation is a regulation that classifies data having same category or attribute into a same group.

4. The data management device according to claim 1, further comprising:
a notification part configured to notify the user of the terminal device about a candidate for the usage condition of the data for each of the groups; and
a usage condition acquisition part configured to acquire the usage condition of the data with respect to the candidate for the usage condition of the data for each of the groups notified of by the notification part,
wherein the usage condition setting part sets the usage condition for each of the groups on the basis of the usage condition acquired by the usage condition acquisition part.

5. The data management device according to claim 1, wherein the usage condition includes at least one of whether collection of the data is allowed, a range of a disclosure recipient of the data, a disclosure range of the data to the disclosure recipient, and a disclosure time or period of the data to the disclosure recipient.

6. The data management device according to claim 1, further comprising:
a price calculation part configured to calculate a price paid to the user by the service provider with respect to the disclosed data on the basis of the usage condition set by the usage condition setting part; and
a payment processing part configured to perform processing of causing the service provider to pay the price calculated by the price calculation part to the user.

7. The data management device according to claim 6, wherein the price calculation part calculates the price on the basis of a range of the disclosure recipient of the data or a disclosure range of the data.

8. The data management device according to claim 6, wherein the price calculation part calculates the price on the basis of a degree of rarity applied to the data in advance or a degree of demand applied to the data in advance.

9. The data management device according to claim 1, further comprising:
a management cost calculation part configured to calculate management cost of the data paid to the service provider by the user with respect to the data that is not disclosed on the basis of the usage condition set by the usage condition setting part; and
a payment processing part configured to perform processing of causing the user to pay the management cost calculated by the management cost calculation part to the service provider.

10. The data management device according to claim 1, further comprising:
an extraction part configured to extract the data or some of the data on the basis of the usage condition set by the usage condition setting part from one or more pieces of data classified into the groups by the data classification part,
wherein the providing part provides the data or some of the data extracted by the extraction part to the outside.

11. The data management device according to claim 1, wherein the terminal device is provided on a moving body, the data management device further comprises:
a detector configured to detect that the user has boarded the moving body;
a notification part configured to notify the user of the terminal device about the candidate for the usage condition of the data for each of the groups when the detector detects that the user has boarded the moving body; and
a usage condition acquisition part configured to acquire the usage condition of the data with respect to the candidate for the usage condition of the data for each of the groups notified of by the notification part, and
the usage condition setting part sets the usage condition for each of the groups on the basis of the usage condition acquired by the usage condition acquisition part.

12. The data management device according to claim 1, further comprising:
a detector configured to detect that the user has boarded the moving body;
a notification part configured to notify the user of the terminal device about the candidate for the usage condition of the data for each of the groups when the detector detects that the user has boarded the moving body; and
a usage condition acquisition part configured to acquire the usage condition of the data with respect to the candidate for the usage condition of the data for each of the groups notified of by the notification part,
wherein the usage condition setting part sets the usage condition for each of the groups on the basis of the usage condition acquired by the usage condition acquisition part.

13. The data management device according to claim 11, wherein the data of the user includes moving body information related to an inside and the outside of the moving body, and
the collection part collects the moving body information even when the user is not boarding the moving body.

14. The data management device according to claim 1, wherein the collection part discards the data of the group in which the usage condition was not set without collecting it.

15. The data management device according to claim 4, wherein the notification part notifies the user that the data is provided to the service provider when the usage condition is not set for the data.

16. The data management device according to claim 1, further comprising:
an interpretation part configured to acquire a sound of the user and interpret content of speech of the user contained in the acquired sound; and
an agent controller configured to generate a sound that speaks to the user on the basis of the content of the speech interpreted by the interpretation part, wherein the collection part collects the data of the user on the basis of the content of the speech of the user interpreted by the interpretation part.

17. The data management device according to claim 16, wherein the agent controller generates a sound that provides to the user a candidate for the usage condition which is set for each of the groups or each piece of the data,
the interpretation part interprets content of the user's speech that selects the usage condition on the basis of the candidate for the usage condition provided by the agent controller, and
the usage condition setting part sets the usage condition selected by the user for each of the groups or for each piece of the data on the basis of the content of the user's speech interpreted by the interpretation part.

18. A data management method of causing a computer to:
collect data of a user from a terminal device of the user or a device of a service provider that provides information to the user,
classify the data of the user that is a target to be collected into groups on the basis of a predetermined regulation,
set one or more usage conditions of data classified into the groups for each of the groups, and
provide the data to an outside on the basis of the set usage condition of each of the groups.

19. A program configured to cause a computer to:
collect data of a user from a terminal device of the user or a device of a service provider that provides information to the user,
classify the data of the user that is a target to be collected into groups on the basis of a predetermined regulation,
set one or more usage conditions of data classified into the groups for each of the groups, and
provide the data to an outside on the basis of the set usage condition of each of the groups.
